(19) United States
(12) Patent Application Publication
(10) Pub. No.: US 2025/0161880 A1
(43) Pub. Date: May 22, 2025

(54) ELECTROLYZERS AND USE OF THE SAME FOR CARBON DIOXIDE CAPTURE AND MINING

(71) Applicant: The Johns Hopkins University, Baltimore, MD (US)

(72) Inventors: Chao WANG, Ellicott City, MD (US); Hao SHEN, Baltimore, MD (US); Han ZONG, Baltimore, MD (US); Yulin LIU, Baltimore, MD (US)

(21) Appl. No.: 19/032,902

(22) Filed: Jan. 21, 2025

Related U.S. Application Data
(63) Continuation of application No. PCT/US2023/071105, filed on Jul. 27, 2023.
(60) Provisional application No. 63/369,699, filed on Jul. 28, 2022.
(60) Provisional application No. 63/375,088, filed on Sep. 9, 2022.

(51) Int. Cl. B01D 61/44; B01D 53/62; B01D 53/78; B01D 61/46; C22B 3/06

(52) U.S. Cl. CPC B01D 61/445; B01D 53/62; B01D 53/78; B01D 61/46; B01D 2251/604; B01D 2257/504; C22B 3/06

(57) ABSTRACT

Disclosed herein is an electro-synthesizer unit comprising a first compartment comprising a cathode and a first electrolyte, a second compartment comprising an anode and a second electrolyte and a third compartment comprising a third electrolyte. The unit is configured to produce acid and base solution at desired concentrations. Also disclosed are methods of using the electro-synthesizer unit and producing the acid and base solution at desired concentrations. Also disclosed are systems for direct capturing of carbon dioxide. Also disclosed are mining systems utilizing the disclosed herein electro-synthesizer units.

### CROSS-REFERENCE TO RELATED APPLICATIONS

This application claims the benefit of U.S. Provisional Application No. 63/369,699, filed Jul. 28, 2022, and U.S. Provisional Application No. 63/375,088, filed Sep. 9, 2022, the contents of which are incorporated herein by reference in their entirety.

### TECHNICAL FIELD

This application relates generally to electrochemical cells configured to form acid and base solutions in the desired concentrations. The application is further directed to capture carbon dioxide and uses the disclosed systems for mining.

### BACKGROUND

The necessity to reduce the carbon dioxide footprint of mankind has led to the development of many processes wherein CO₂, the major greenhouse gas accounting for global warming, is used as feedstock. Ironically, these emerging technologies are hampered by the limited availability of CO₂. Processes to capture CO₂ from gases rich in CO₂, such as industrial flue gases, have been developed but cannot account for the demand for CO₂. Furthermore, such processes may lower the emission of CO₂ into the environment, but the concentration of CO₂ already present in the environment is not affected. Hence, there is a need for capturing CO₂ directly from the air, which would lower the CO₂ concentration in the environment.

Devices and processes for capturing CO₂ from the air are known in the art. For example, devices containing a porous sorbent material wherein the sorbent adsorbs or binds the CO₂ and systems that dissolve CO₂ in an aqueous solution for capture and subsequent release are known. Disadvantageously, the systems and processes of the prior art tend to be very energy intensive.

There is a continuing need for an efficient and economically viable apparatus for capturing CO₂ directly from air or other emission sources. Described herein is the apparatus and method of using the same that takes advantage of an ambient-condition acid-base reaction to capture and release CO₂, which is energy-efficient because it avoids high-temperature calcination or pressure-swing processes and is more sustainable with high compatibility with renewable energy sources.

Also, mineral beneficiation processes involving extraction and processing of ore are one of the most energy- and emission-intensive industrial sectors. The depletion of high-grade mineral reservoirs and the growing demands for critical elements in the economy and new energy technology development have caused the rapid rise of commodity prices over the last decades. One way to address this sustainability challenge is to explore unconventional resources such as gangue minerals and mining tailings. However, it remains challenging to extract the targeted metals from such low-concentration feedstocks at high energy efficiencies and reduced emissions.

These needs and other needs are at least partially satisfied by the present disclosure.

### SUMMARY

The present disclosure is directed to an electro-synthesizer unit, wherein the electro-synthesizer unit is a flow unit comprising: a first compartment comprising: a first inlet configured to receive a first flow of a first electrolyte solution; a cathode; the first electrolyte solution that is in electrical and fluid communication with the cathode; wherein a pH of the first electrolyte solution is about 6≤pH≤15.5; wherein the cathode is configured to generate a hydrogen gas and a hydroxide; one or more outlets configured to remove the generated hydrogen gas and/or a base solution comprising the generated hydroxide from the first compartment; a second compartment comprising: a second inlet configured to receive a second flow of a second electrolyte solution, a third inlet configured to receive a stream comprising a hydrogen gas, an anode; and the second electrolyte solution that is in electrical and fluid communication with the anode; wherein a pH of the second electrolyte solution is about −1.5≤pH≤8; wherein the anode is configured to oxidate the hydrogen gas to generate hydrogen ions; an outlet configured to remove an acid solution comprising the generated hydrogen ions from the second compartment; and a third compartment positioned between and in fluid communication with the first compartment and the second compartment, wherein the third compartment is separated from the first compartment with one or more cation exchange membranes and is separated from the second compartment with one or more anion exchange membranes; wherein the third compartment comprises: a fourth inlet configured to receive a third flow of a third electrolyte solution, the third electrolyte solution, wherein a pH of the third electrolyte solution is about 4≤pH≤10; and an outlet configured to remove the third electrolyte from the third compartment.

In further aspects, the stream comprises the hydrogen gas generated in the first compartment. In other aspects, the stream comprising the generated hydrogen gas is directly fed from the first compartment to the second compartment. While in still further aspects, the stream comprises the hydrogen gas supplied from an external source.

Also disclosed herein is a system comprising one or more of the electro-synthesizer units of any examples disclosed herein.

In still further aspects, disclosed herein is a method comprising: providing the electro-synthesizer unit of any examples disclosed herein, or the system of any examples disclosed herein; flowing the first electrolyte, the second electrolyte, and the third electrolyte; generating a hydrogen gas stream and a hydroxide on the cathode in the first compartment; generating hydrogen ions on the anode in the second compartment; directing the generated hydrogen gas stream into the second compartment; and collecting a generated base solution and a generated acid solution.

Also disclosed herein is a system comprising any of the disclosed herein flow electro-synthesizer units configured to produce an acid solution and a base solution; one or more carbon dioxide capturing apparatuses that is in fluid communication with the one or more flow electro-synthesizer units and that are configured to capture a carbon dioxide from a gas source by converting the carbon dioxide to a bicarbonate solution, carbonate solution, or a combination thereof.

Still further disclosed herein is a method of directly capturing carbon dioxide from a gas source, wherein the method comprises: providing one or more of the disclosed herein systems, comprising any of the disclosed herein flow electro-synthesizer units; electrochemically generating a hydrogen gas and hydroxide ions on the cathode in the first compartment; flowing a stream comprising a generated hydrogen gas, a hydrogen gas provided by an external source, or a combination thereof, to the second compartment, such that electrochemically generated hydrogen ions are formed on the anode; and directing a portion of the cathode electrolyte comprising the generated hydroxide ions to one or more carbon dioxide capturing apparatuses configured to capture a carbon dioxide from a gas source by converting the carbon dioxide to a bicarbonate solution, carbonate solution, or a combination thereof.

Still further disclosed herein is a system comprising any of the disclosed herein flow electro-synthesizer units configured to produce an acid solution and a base solution; one or more carbon dioxide capturing apparatuses that is in fluid communication with the one or more flow electro-synthesizer units and that are configured to capture a carbon dioxide from a gas source by converting the carbon dioxide to a bicarbonate solution, carbonate solution, or a combination thereof; one or more acid leachers that are in fluid communication with the one or more flow electro-synthesizer units and that are configured to receive a mineral ore comprising one or more metal minerals and to form one or more solubilized minerals; and one or more precipitators that are in fluid communication with the one or more acid leachers and with the one or more carbon dioxide capturing apparatuses and that is configured to precipitate at least a portion of the one or more solubilized minerals.

Still further disclosed is a method comprising providing one or more of the disclosed herein systems, comprising any of the disclosed herein flow electro-synthesizer units; electrochemically generating a hydrogen gas and hydroxide ions on the cathode in the first compartment; flowing a stream comprising a generated hydrogen gas, a hydrogen gas provided by an external source, or a combination thereof, such that electrochemically generated hydrogen ions are formed on the anode; directing a portion of the cathode electrolyte comprising the hydroxide ions to one or more carbon dioxide capturing apparatuses configured to capture a carbon dioxide from a gas source by converting the carbon dioxide to a bicarbonate solution, carbonate solution, or a combination thereof; directing a portion of the anode electrolyte comprising hydrogen ions to one or more acid leachers, wherein the one or more acid leachers comprise a mineral ore comprising one or more metal minerals, and forming an aqueous solution comprising one or more solubilized minerals; directing the bicarbonate solution, carbonate solution, or a combination thereof and the aqueous solution comprising one or more solubilized minerals to one or more precipitators to precipitate at least a portion of the one or more solubilized minerals. In still further aspects, the method is a carbon-negative method.

Still further disclosed is a system comprising any of the disclosed herein flow electro-synthesizer units configured to produce an acid solution and a base solution; one or more acid leachers that are in fluid communication with the one or more flow electro-synthesizer and that are configured to receive a mineral ore comprising one or more metal minerals and form one or more solubilized minerals; and one or more enrichers that are in fluid communication with the one or more acid leachers and with the one or more flow electro-synthesizer units and that are configured to form an enriched mineral ore.

Still further disclosed is a method comprising providing one or more of the disclosed herein systems, comprising any of the disclosed herein flow electro-synthesizer units, electrochemically generating a hydrogen gas and hydroxide ions on the cathode in the first compartment; flowing a stream comprising a generated hydrogen gas, a hydrogen gas provided by an external source, or a combination thereof, such that electrochemically generated hydrogen ions are formed on the anode; directing a portion of the anode electrolyte comprising hydrogen ions to one or more acid leachers, wherein the one or more acid leachers comprise a mineral ore comprising one or more metal minerals, and forming an aqueous solution comprising one or more solubilized minerals; directing a portion of the cathode electrolyte comprising the hydroxide ions to the one or more enrichers, directing a portion of the aqueous solution comprising one or more solubilized minerals to the one or more enrichers forming an enriched mineral ore in the one or more enrichers. In still further aspects, the method is a carbon-neutral method.

Additional advantages will be set forth in part in the description which follows, and in part will be obvious from the description or can be learned by practice of the aspects described below. The advantages described below will be realized and attained by means of the chemical compositions, methods, and combinations thereof, particularly pointed out in the appended claims. It is to be understood that both the foregoing general description and the following detailed description are exemplary and explanatory only and is not restrictive of the invention, as claimed.

### BRIEF DESCRIPTION OF DRAWINGS

FIG. 1 depicts an exemplary electro-synthesizer unit in one aspect.

FIG. 2 depicts an exemplary system comprising four (4) electro-synthesizer units.

FIG. 3 depicts methods of using an exemplary electro-synthesizer unit in one aspect.

FIG. 4 depicts methods of using an exemplary electro-synthesizer unit in a different aspect.

FIGS. 5A-5B show an exemplary electro-synthesizer unit for the production of HCl in one aspect (FIG. 5A); and a relationship between the electro-synthesizer unit voltage at a current density of 100 mA/cm² and pH of the solutions formed in the electro-synthesizer unit (FIG. 5B).

FIGS. 6A-6D show a relationship between the electro-synthesizer unit voltage and formed acid concentration. FIG. 6A shows an exemplary single-pass H₂SO₄ production formed at different current densities. 1 M Na₂SO₄ is used as an electrolyte in all three compartments. The acid flow rate was 8 mL/h, and the base flow rate was 100 mL/h. FIG. 6B shows an exemplary H₂SO₄ production with a solution recirculation system at a current density of 160 mA/cm². 1 M Na₂SO₄ is used as an electrolyte in a third compartment. Acid/base flow rate was 100 mL/h The first and the second electrolytes comprise 0.5 M Na₂SO₄. FIG. 6C shows an exemplary H₂SO₄ production with a solution recirculation system driven with centrifugal pumps at a current density of 160 mA/cm². 1.5 M Na₂SO₄ is used as an electrolyte in a third compartment. Acid/base flow rate was 250 mL/h. The first and the second electrolytes comprise 0.5 M Na₂SO₄. FIG. 6D shows an exemplary H₂SO₄ production with a solution recirculation system at a current density of 160 mA/cm². 1.5 M Na₂SO₄ is used as an electrolyte in a third compartment. Acid/base flow rate was 100 mL/h. The first and the second electrolytes comprise 0.5 M Na₂SO₄.

FIG. 7 shows an exemplary system design for direct air capture.

FIG. 8 shows an exemplary system design for carbon-negative mining.

FIG. 9 shows an exemplary system design for pH-based mining.

FIGS. 10A-10E show exemplary ores (FIG. 10A), XRD images of the same (FIGS. 10B-10D) and metal content of the same (FIG. 10E).

FIGS. 11A-11C show metal separation using a system described in FIG. 9 in one aspect.

FIGS. 12A-12B show metal separation using a system described in FIG. 9 in another aspect.

FIG. 13 shows metal separation using a system described in FIG. 9 in a different aspect.

FIGS. 14A-14B show metal separation using a system described in FIG. 8 after the leaching step.

FIGS. 15A-15B show metal separation using a system described in FIG. 8 after the carbonation step.

The accompanying figures, which are incorporated in and constitute a part of this specification, illustrate several aspects described below.

### DETAILED DESCRIPTION

The present invention can be understood more readily by reference to the following detailed description, examples, drawings, and claims, and their previous and following description. However, before the present articles, systems, and/or methods are disclosed and described, it is to be understood that this invention is not limited to the specific or exemplary aspects of articles, systems, and/or methods disclosed unless otherwise specified, as such can, of course, vary. It is also to be understood that the terminology used herein is for the purpose of describing particular aspects only and is not intended to be limiting.

The following description of the invention is provided as an enabling teaching of the invention in its best, currently known aspect. To this end, those skilled in the relevant art will recognize and appreciate that many changes can be made to the various aspects of the invention described herein while still obtaining the beneficial results of the present invention. It will also be apparent that some of the desired benefits of the present invention can be obtained by selecting some of the features of the present invention without utilizing other features. Accordingly, those of ordinary skill in the pertinent art will recognize that many modifications and adaptations to the present invention are possible and may even be desirable in certain circumstances and are a part of the present invention. Thus, the following description is again provided as illustrative of the principles of the present invention and not in limitation thereof.

### Definitions

As used herein, the terms “optional” or “optionally” mean that the subsequently described event or circumstance can or cannot occur and that the description includes instances where said event or circumstance occurs and instances where it does not.

It is appreciated that certain features of the disclosure, which are, for clarity, described in the context of separate aspects, can also be provided in combination in a single aspect. Conversely, various features of the disclosure, which are, for brevity, described in the context of a single aspect, can also be provided separately or in any suitable subcombination.

As used in the description and the appended claims, the singular forms “a,” “an,” and “the” include plural referents unless the context clearly dictates otherwise. Thus, for example, a reference to “a unit” includes two or more such units, and a reference to “a membrane” includes two or more such membranes and the like.

It is also to be understood that the terminology used herein is for the purpose of describing particular aspects only and is not intended to be limiting. As used in the specification and in the claims, the term “comprising” can include the aspects “consisting of” and “consisting essentially of.” Unless defined otherwise, all technical and scientific terms used herein have the same meaning as commonly understood by one of ordinary skill in the art to which this invention belongs. In this specification and in the claims which follow, reference will be made to a number of terms that shall be defined herein.

For the terms “for example” and “such as,” and grammatical equivalences thereof, the phrase “and without limitation” is understood to follow unless explicitly stated otherwise.

The expressions “ambient temperature” and “room temperature” as used herein are understood in the art and refer generally to a temperature from about 20° C. to about 35° C.

Notwithstanding that the numerical ranges and parameters setting forth the broad scope of the disclosure are approximations, the numerical values set forth in the specific examples are reported as precisely as possible. Any numerical value, however, inherently contains certain errors necessarily resulting from the standard deviation found in their respective testing measurements. Furthermore, when numerical ranges of varying scope are set forth herein, it is contemplated that any combination of these values, inclusive of the recited values, may be used. Further, ranges can be expressed herein as from “about” one particular value and/or to “about” another particular value. When such a range is expressed, another aspect includes from the one particular value and/or to the other particular value.

Similarly, when values are expressed as approximations, by use of the antecedent “about,” it will be understood that the particular value forms another aspect. It will be further understood that the endpoints of each of the ranges are significant both in relation to the other endpoint and independently of the other endpoint. Unless stated otherwise, the term “about” means within 5% (e.g., within 2% or 1%) of the particular value modified by the term “about.”

Throughout this disclosure, various aspects of the invention can be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, a description of a range such as from 1 to 6 should be considered to have specifically disclosed subranges such as from 1 to 3, from 1 to 4, from 1 to 5, from 2 to 4, from 2 to 6, from 3 to 6, etc., as well as individual numbers within that range, for example, 1, 2, 2.7, 3, 4, 5, 5.3, 6 and any whole and partial increments therebetween. This applies regardless of the breadth of the range.

As used herein, the term “composition” is intended to encompass a product comprising the specified ingredients in the specified amounts, as well as any product which results, directly or indirectly, from a combination of the specified ingredients in the specified amounts.

References in the specification and concluding claims to parts by weight of a particular element or component in a composition denotes the weight relationship between the element or component and any other elements or components in the composition or article for which a part by weight is expressed. Thus, in a mixture containing 2 parts by weight of component X and 5 parts by weight, components Y, X, and Y are present at a weight ratio of 2:5 and are present in such a ratio regardless of whether additional components are contained in the mixture.

A weight percent (wt. %) of a component, unless specifically stated to the contrary, is based on the total weight of the formulation or composition in which the component is included.

It will be understood that when an element is referred to as being “connected” or “coupled” or “being in fluid and/or electrical communication” to another element, it can be directly connected, coupled, or be on fluid and/or electrical communication to the other element, or intervening elements may be present. In contrast, when an element is referred to as being “directly connected,” “directly coupled,” or “in direct fluid and/or electrical communication” to another element, there are no intervening elements present. Other words used to describe the relationship between elements or layers should be interpreted in a like fashion (e.g., “between” versus “directly between,” “adjacent” versus “directly adjacent,” “on” versus “directly on”).

As used herein, the term “and/or” includes any and all combinations of one or more of the associated listed items.

It will be understood that the terms “first,” “second,” etc., may be used herein to describe various elements, components, solutions, regions, layers, and/or sections. These elements, components, solutions, regions, layers, and/or sections should not be limited by these terms. These terms are only used to distinguish one element, component, solution, region, layer, or section from another element, component, solution, region, layer, or section. Thus, a first element, component, solution, region, layer, or section discussed below could be termed a second element, component, solution, region, layer, or section without departing from the teachings of example embodiments.

As used herein, the term “substantially” means that the subsequently described event or circumstance completely occurs or that the subsequently described event or circumstance generally, typically, or approximately occurs.

Still further, the term “substantially” can, in some aspects, refer to at least about 80%, at least about 85%, at least about 90%, at least about 91%, at least about 92%, at least about 93%, at least about 94%, at least about 95%, at least about 96%, at least about 97%, at least about 98%, at least about 99%, or about 100% of the stated property, component, composition, or other condition for which substantially is used to characterize or otherwise quantify an amount.

In other aspects, as used herein, the term “substantially free,” when used in the context of a composition or component of a composition that is substantially absent, is intended to refer to an amount that is then about 1% by weight, e.g., less than about 0.5% by weight, less than about 0.1% by weight, less than about 0.05% by weight, or less than about 0.01% by weight of the stated material, based on the total weight of the composition.

As used herein, the term “recirculated-in-a-loop” defines a system where all streams of the system are recirculating within the loop. It is understood that substantially all streams disclosed herein are recirculated. However, in some examples, if needed, external streams are provided. Numerous general purpose or special purpose computing devices environments or configurations can be used with the systems and methods disclosed herein. Examples of well-known computing devices, environments, and/or configurations that can be suitable for use include but are not limited to, personal computers, server computers, handheld or laptop devices, smartphones, multiprocessor systems, microprocessor-based systems, network personal computers (PCs), minicomputers, mainframe computers, embedded systems, distributed computing environments that include any of the above systems or devices, and the like.

Computing devices, as disclosed herein, can contain communication connection(s) that allow the device to communicate with other devices if desired. Computing devices can also have input device(s) such as a keyboard, mouse, pen, voice input device, touch input device, etc. Output device(s) such as a display, speakers, printer, etc., can also be included. All these devices are well-known in the art and need not be discussed at length here.

Computer-executable instructions, such as program modules being executed by a computer, can be used. Generally, program modules include routines, programs, objects, components, data structures, etc., that perform particular tasks or implement particular abstract data types. Distributed computing environments can be used where tasks are performed by remote processing devices that are linked through a communications network or other data transmission medium. In a distributed computing environment, program modules and other data can be located in both local and remote computer storage media, including memory storage devices.

In its most base configuration, a computing device typically includes at least one processing unit and memory. Depending on the exact configuration and type of computing device, memory can be volatile (such as random-access memory (RAM)), non-volatile (such as read-only memory (ROM), flash memory, etc.), or some combination of the two.

Computing devices can have additional features/functionality. For example, a computing device can include additional storage (removable and/or non-removable), including, but not limited to, magnetic or optical disks or tape.

Computing device typically includes a variety of computer-readable media. Computer-readable media can be any available media that can be accessed by the device and includes both volatile and non-volatile media, removable and non-removable media.

Computer storage media include volatile and non-volatile and removable and non-removable media implemented in any method or technology for information storage, such as computer-readable instructions, data structures, program modules, or other data. Memory, removable storage, and non-removable storage are all examples of computer storage media. Computer storage media include but are not limited to, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computing device. Any such computer storage media can be part of a computing device.

Computing devices, as disclosed herein, can contain communication connection(s) that allow the device to communicate with other devices. The connection can be wireless or wired. Computing devices can also have input device(s) such as a keyboard, mouse, pen, voice input device, touch input device, etc. Output device(s) such as a display, speakers, printer, etc., can also be included. All these devices are well-known in the art and need not be discussed at length here.

It should be understood that the various techniques described herein can be implemented in connection with hardware components or software components or, where appropriate, with a combination of both. Illustrative types of hardware components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc. The methods and apparatus of the presently disclosed subject matter, or certain aspects or portions thereof, can take the form of program code (i.e., instructions) embodied in tangible media, such as CD-ROMs, hard drives, or any other machine-readable storage medium where, when the program code is loaded into and executed by a machine, such as a computer, the machine becomes an apparatus for practicing the presently disclosed subject matter.

While aspects of the present invention can be described and claimed in a particular statutory class, such as the system statutory class, this is for convenience only and one of ordinary skill in the art will understand that each aspect of the present invention can be described and claimed in any statutory class. Unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is in no way intended that an order be inferred in any respect. This holds for any possible non-express basis for interpretation, including matters of logic with respect to the arrangement of steps or operational flow, plain meaning derived from grammatical organization or punctuation, or the number or type of aspects described in the specification.

The present invention may be understood more readily by reference to the following detailed description of various aspects of the invention and the examples included therein and to the Figures and their previous and following description.

### Electro-Synthesizer Unit

Direct electrosynthesis of sodium hydroxide (NaOH) and hydrochloric acid (HCl) or sulfuric acid (H₂SO₄) from sodium chloride (NaCl) or sodium sulfate (Na₂SO₄) brine can be a cost-effective process to generate both concentrated NaOH and HCl/H₂SO₄ solution for chemical industries. This electrosynthesis process usually uses the water splitting reaction to generate H⁺ and OH⁻, then combine with the Cl⁻ and Na⁺ produced by splitting the NaCl with two ion-exchange membranes for acid and base production. The half-reactions and their standard potential of anode (R2) and cathode (R1) are,

At pH=14, 2 H₂O−2e⁻→H₂+2 OH⁻ φ=−0.83 V vs. SHE (R1)

At pH=0, 2 H₂O+4e⁻→O₂+4 H⁺ φ=1.23 V vs. SHE (R2)

Various types of electrolyzers are known and used currently in the field. One of the challenges of using known electrolyzers is the high pH difference between various chambers of the device. As a result, the concentrations of electro-synthesized acid and base are limited to less than 0.5 mol/L. To solve the challenge of maintaining a high pH difference (0 to 14) in a single electrolyzer while still achieving a high concentration of acid and base, the bipolar membrane electrodialysis (BMED) method has been employed. While such a method allows obtaining acid/base concentrations up to 3 mol/L, it still suffers from low energy efficiency and high capital cost.

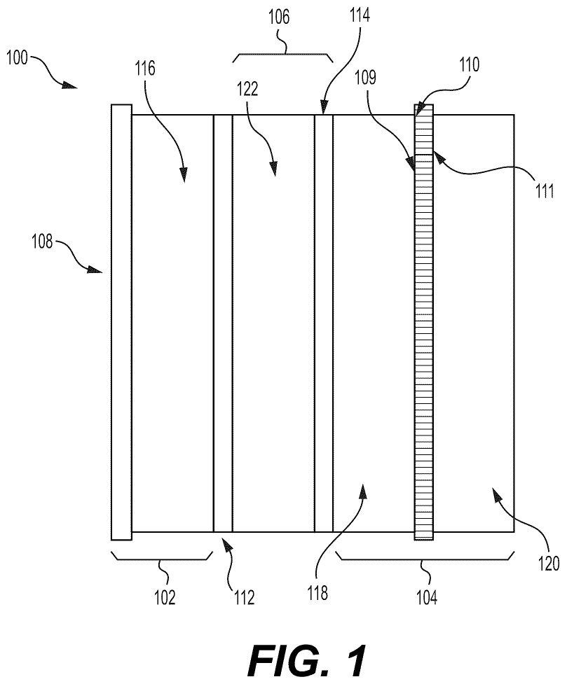

Disclosed herein are aspects directed to an electro-synthesizer unit. In certain aspects, the electro-synthesizer unit is a flow unit. In further aspects, the electro-synthesizer unit comprises a number of compartments. FIG. 1 shows an exemplary electro-synthesizer unit 100. The electro-synthesizer unit 100 comprises a first compartment 102, a second compartment 104, and a third compartment 106. The first compartment 102 can comprise a first inlet (not shown) configured to receive a first flow of a first electrolyte solution and a cathode 108. The first compartment further comprises the first electrolyte solution 116, which is in electrical and fluid communication with the cathode 108. In such exemplary and unlimiting aspects, a pH of the first electrolyte solution can be about 6≤pH≤15.5, including exemplary values of about 6, about 6.5, about 7, about 7.5, about 8, about 8.5, about 9, about 9.5, about 10, about 10.5, about 11, about 11.5, about 12, about 12.5, about 13, about 13.5, about 14, about 14.5, about 15, and about 15.5. It is understood that at any point, the first compartment can comprise the first electrolyte having a pH value that falls within any two foregoing values. In yet still further aspects, the pH of the first electrolyte can change during the unit operation. While in yet still further aspects, the pH of the first electrolyte is kept substantially the same during the unit operation, depending on the desired outcome. In still further aspects, the cathode is configured to generate a hydrogen gas and a hydroxide. The first compartment further comprises one or more outlets (not shown in FIG. 1) configured to remove the generated hydrogen gas and/or a base solution comprising the generated hydroxide from the first compartment.

The first electrolyte comprises a base. Any known in the art bases can be used. For example, the base can comprise one or more of sodium hydroxide, lithium hydroxide, potassium hydroxide, magnesium hydroxide, calcium hydroxide, ammonium hydroxide, amine-based bases, sodium acetate, or any combination thereof. In still further aspects, the bases can comprise amine-based bases, such as primary, secondary, tertiary amines, or any combination thereof. It is understood that other organic bases can be utilized. In still further aspects, the base can be strong or weak, depending on the desired pH, as commonly defined in chemical arts. In yet still further aspects, the bases can also comprise Lewis bases. It is understood that the base can be present in any concentration to provide the desired pH. The concentration can be measured in M, or it can be measured in wt %, depending on the desired application. In still further aspects, the base can be present in any concentration from 0 M to about 20 M, including exemplary values about 0.001 M, about 0.005 M, about 0.01 M, about 0.05 M, about 0.1 M, about 0.5 M, about 1 M, about 2 M, about 3 M, about 4 M, about 5 M, about 6 M, about 7 M, about 8 M, about 9 M, about 10 M, about 11 M, about 12 M, about 13 M, about 14 M, about 15 M, about 16 M, about 17 M, about 18 M, and about 19 M. It is understood that these values are only exemplary, and the base can be present in a concentration having any values between any two foregoing values.

In still further aspects, the first electrolyte comprises one or more inorganic salts. In some exemplary and unlimiting aspects, the first electrolyte can comprise a salt without the presence of the base. Yet, in other aspects, the first electrolyte can comprise only a base. In yet still further aspects, the first electrolyte can comprise the salt and the base in any desired concentration. It is understood that the salt is present in the first electrolyte can be at any concentration before its saturation. In certain aspects, the salt and the base present in the electrolyte can have the same cation or a different cation. In yet other aspects, the combination of various salts (having the same cations but different anions or the same anions but different cations) can be present. Yet, in still further aspects, the combination of the various bases can also be present in the first electrolyte.

In still further aspects, the one or more inorganic salt can comprise chlorides, sulfates, nitrates, phosphates, citrates, formates, lactates, tartrates, malates, fumarates, oxalates, succinates, gluconates, ascorbates, acetates of alkaline metals and/or alkaline-earth metals, or mixtures thereof.

The disclosed herein unit 100 further comprises a second compartment 104. The second compartment 104 comprises an anode 110. The anode 110 has a first surface 109 and a second surface 111. In still further aspects, the second compartment 104 comprises a second inlet (not shown) configured to receive a second flow of a second electrolyte solution 118 and a third inlet (not shown) configured to receive a stream 120 comprising a hydrogen gas.

In still further aspects, the second inlet of the second compartment extends into a first channel, and the third inlet extends into a second channel. In such aspects, the first channel is positioned between the anion exchange membrane 114 and the first surface 109 of the anode 110 and hosts the second electrolyte 118. While in other aspects, the second channel is positioned abut the second surface 111 of the anode 110 and is configured to receive the hydrogen gas stream 120.

In certain aspects, the hydrogen gas stream 120 can comprise the hydrogen gas generated in the first compartment. In such aspects, the generated hydrogen gas is directly fed from the first compartment to the second compartment, forming the looping of the hydrogen gas between the first and the second compartment of the unit. However, also disclosed herein are aspects wherein the hydrogen gas stream 120 comprises a hydrogen gas supplied from any external source, such as a hydrogen tank, externally generated hydrogen, and the like. In yet still further aspects, the hydrogen gas stream 120 can comprise both the hydrogen generated in the first compartment and the hydrogen gas received from the external source. In still further aspects, disclosed are implementations where an operator can switch the supply of the hydrogen gas stream 120 as desired.

In still further aspects, the second electrolyte comprises an acid. Any known in the art acids can be used. For example, the acid can comprise one or more of hydrochloric acid, hydrobromic acid, hydroiodic acid, sulfurous acid, sulfuric acid, nitric acid, phosphorous acid, phosphoric acid, hypochlorous acid, chlorous acid, chloric acid, perchloric acid, formic acid, acetic acid, carbonic acid, or any combination thereof. In still further aspects, the acids can comprise organic acids. In still further aspects, the acid can be strong or weak, depending on the desired pH, as commonly defined in chemical arts. In yet still further aspects, the acid can also comprise Lewis acids. It is understood that the acid can be present in any concentration to provide for the desired pH. The concentration can be measured in M, or it can be measured in wt %, depending on the desired application. In still further aspects, the acid can be present in any concentration from 0 M to about 10 M, including exemplary values about 0.001 M, about 0.005 M, about 0.01 M, about 0.05 M, about 0.1 M, about 0.5 M, about 1 M, about 2 M, about 3 M, about 4 M, about 5 M, about 6 M, about 7 M, about 8 M, and about 9 M. It is understood that these values are only exemplary, and the acid can be present in a concentration having any values between any two foregoing values.

In still further aspects, the second electrolyte comprises one or more inorganic salts. In some exemplary and unlimiting aspects, the second electrolyte can comprise a salt without the presence of the acid. Yet, in other aspects, the second electrolyte can comprise only an acid. In yet still further aspects, the second electrolyte can comprise the salt and the acid in any desired concentration. It is understood that the salt present in the second electrolyte can be at any concentration before its saturation. In certain aspects, the salt and the acid present in the electrolyte can have the same cation or a different cation. In yet other aspects, the combination of various salts (having the same cations but different anions or the same anions but different cations) can be present. Yet in still further aspects, the combination of the various acids can also be present in the second electrolyte.

In still further aspects, the one or more inorganic salt can comprise chlorides, sulfates, nitrates, phosphates, citrates, formates, lactates, tartrates, malates, fumarates, oxalates, succinates, gluconates, ascorbates, acetates of alkaline metals and/or alkaline-earth metals, or mixtures thereof.

It is understood that using hydrogen to generate hydrogen ions (either by looping the hydrogen from the first compartment to the second compartment or using both streams of hydrogen) improves the overall efficiency of the process. The hydrogen-depolarized reaction reduces both the energy cost and the electrode polarization in this electrolysis process. For example, in aspects where the pH gradient between the compartments is extreme (for example, pH=14 in the first compartment and pH=0 in the second compartment), the hydrogen-induced loop will only cost 0.83 V for the pH gradient, which is 60% more efficient than the typical salt splitting process. The half-reactions and their standard potential of anode (R4) and cathode (R3) are,

At pH=14, 2 H₂O−2e⁻→H₂+2 OH⁻ φ=−0.83 V vs. SHE (R3)

At pH=0, H₂+2e⁻→2 H⁺ φ=0 V vs. SHE (R4)

In one aspect, the second electrolyte solution 118 is in electrical and fluid communication with the anode. For example, the second electrolyte solution 118 is in electrical and fluid communication with the first surface 109 of the anode 110. In still further aspects, a pH of the second electrolyte solution is about −1.5≤pH≤8, including exemplary values of about −1.5, about −1, about −0.5, 0, about 0.5, about 1, about 1.5, about 2, about 2.5, about 3, about 3.5, about 4, about 4.5, about 5, about 5.5, about 6, about 6.5, about 7, about 7.5, and about 8. It is understood that at any point of, the second compartment can comprise the second electrolyte having a pH value that falls within any two foregoing values. In yet still further aspects, the pH of the second electrolyte can change during the unit operation. While in yet still further aspects, the pH of the second electrolyte is kept substantially the same during the unit operation, depending on the desired outcome. In still further aspects, the anode is configured to oxidate the hydrogen gas to generate hydrogen ions. In yet still further aspects, the second compartment comprises an outlet (not shown) configured to remove an acid solution comprising the generated hydrogen ions from the second compartment.

The unit 100 further comprises a third compartment 106 positioned between and in fluid communication with the first compartment 102 and the second compartment 104, wherein the third compartment 106 is separated from the first compartment 102 with one or more cation exchange membranes 112 and is separated from the second compartment 104 with one or more anion exchange membranes 114.

In still further aspects, the third compartment 106 comprises a fourth inlet (not shown) configured to receive a third flow of a third electrolyte solution 122. In such aspects, the third electrolyte solution 122, can have a pH of about 4≤pH≤10, including exemplary values of about 4, about 4.5, about 5, about 5.5, about 6, about 6.5, about 7, about 7.5, about 8, about 8.5, about 9, about 9.5, and about 10. It is understood that at any point of, the third compartment can comprise the third electrolyte having a pH value that falls within any two foregoing values. In yet still further aspects, the pH of the third electrolyte can change during the unit operation. While in yet still further aspects, the pH of the third electrolyte is kept substantially the same during the unit operation, depending on the desired outcome. In still further aspects, the third compartment also can comprise an outlet configured (not shown) to remove the third electrolyte from the third compartment.

In still further aspects, the third electrolyte solution can comprise one or more inorganic salts. In still further aspects, the one or more inorganic salt comprises chlorides, sulfates, nitrates, phosphates, citrates, formates, lactates, tartrates, malates, fumarates, oxalates, succinates, gluconates, ascorbates, acetates of alkaline metals and/or alkaline-earth metals, or mixtures thereof. In yet still further aspects, the one or more inorganic salts in the third electrolyte can be referred to as brine.

In still further aspects, while the disclosed above inlets and outlets are not shown in FIG. 1, the skilled practitioner can understand that inlet and outlet can be positioned anywhere within the compartment to allow inflow and outflow of respective streams as described. For example, each of the compartments can have one or more inlets and/or one or more outlets. In some aspects, the generated in the first compartment hydrogen gas and the base solution comprising the generated hydroxide can be removed from the same outlet. Yet in other aspects, the first compartment can comprise two or more outlets. In such exemplary and unlimiting aspects, the generated hydrogen gas stream and the base solution comprising the generated hydroxide can be removed from separate outlets.

In still further aspects, the electro-synthesizer unit can be constructed by any known in the art methods. For example, and without limitations, each compartment can be any vessel configured to receive and retain disclosed above streams. In yet other aspects, the electro-synthesizer unit can comprise a plurality of plates positioned such that the disclosed above compartments are formed. For example and without limitations, each of the first, second and third compartments is defined by two or more plates. It is understood that all materials that are used to form the electro-synthesizer unit are chemically and physically compatible with the electrolytes used in the unit as well as output streams formed in the unit compartments.

In still further aspects, each of the compartments can have any width that can accommodate the desired flow rate of the described above streams. In some aspects, the first compartment can have a width of about 0.01 mm to about 500 mm, including exemplary values of about 0.05 mm, about 0.1 mm, about 0.5 mm, about 1 mm, about 5 mm, about 10 mm, about 15 mm, about 20 mm, about 25 mm, about 50 mm, about 75 mm, about 100 mm, about 125 mm, about 150 mm, about 175 mm, about 200 mm, about 250 mm, about 300 mm, about 350 mm, about 400 mm, and about 450 mm. It is understood that the first compartment can also have any width value that falls within any of the disclosed above values. For example, and without limitations, the width of the first compartment can be about 0.01 mm to about 50 mm, about 1 mm to about 10 mm, or about 5 mm to about 100 mm, and so on.

In aspects where the second compartment has the first and second channels, each channel can have any desired width that suits the streams' preferred flow rates. For example and without limitations, the first channel present in the second compartment has a width of about 0.01 to about 500 mm, including exemplary values of about 0.05 mm, about 0.1 mm, about 0.5 mm, about 1 mm, about 5 mm, about 10 mm, about 15 mm, about 20 mm, about 25 mm, about 50 mm, about 75 mm, about 100 mm, about 125 mm, about 150 mm, about 175 mm, about 200 mm, about 250 mm, about 300 mm, about 350 mm, about 400 mm, and about 450 mm. It is understood that the first channel can also have any width value that falls within any of the disclosed above values. For example, and without limitations, the width of the first channel can be about 0.01 mm to about 50 mm, or about 1 mm to about 10 mm, or about 5 mm to about 100 mm, and so on. In further aspects, the second channel present in the second compartment has a width of about 0.01 to about 500 mm, including exemplary values of about 0.05 mm, about 0.1 mm, about 0.5 mm, about 1 mm, about 5 mm, about 10 mm, about 15 mm, about 20 mm, about 25 mm, about 50 mm, about 75 mm, about 100 mm, about 125 mm, about 150 mm, about 175 mm, about 200 mm, about 250 mm, about 300 mm, about 350 mm, about 400 mm, and about 450 mm. It is understood that the second channel can also have any width value that falls within any of the disclosed above values. For example, and without limitations, the width of the second channel can be about 0.01 mm to about 50 mm, or about 1 mm to about 10 mm, or about 5 mm to about 100 mm, and so on.

In still further aspects, the third compartment can have a width of about 0.01 to about 500 mm, including exemplary values of about 0.05 mm, about 0.1 mm, about 0.5 mm, about 1 mm, about 5 mm, about 10 mm, about 15 mm, about 20 mm, about 25 mm, about 50 mm, about 75 mm, about 100 mm, about 125 mm, about 150 mm, about 175 mm, about 200 mm, about 250 mm, about 300 mm, about 350 mm, about 400 mm, and about 450 mm. It is understood that the third compartment can also have any width value that falls within any of the disclosed above values. For example, and without limitations, the width of the third compartment can be about 0.01 mm to about 50 mm, or about 1 mm to about 10 mm, or about 5 mm to about 100 mm, and so on.

In still further aspects, all compartments can have the same width, while in other aspects, some of the compartments can have the same width, and some of them can have a different width. It is understood that the desired flow rate and coulombic efficiency of the cell can determine the width of the compartment. In yet still further aspects, the width of the compartment can be changed in the cell by introducing (or removing) additional plates, gaskets, membranes, and the like.

In still further aspects, each of the cathode and anode are electrically connected to a power source. In still further aspects, the power source can provide a desired current to achieve the electrochemical reaction to produce the hydroxide ions and hydrogen in the first compartment and the hydrogen ions in the second compartment at desired efficiencies. In certain aspects, the current can have a current density from about 50 mAh/cm² to about 500 mAh/cm², including exemplary values of about 75 mAh/cm², about 100 mAh/cm², about 125 mAh/cm², about 150 mAh/cm², about 175 mAh/cm², about 200 mAh/cm², about 225 mAh/cm², about 250 mAh/cm², about 275 mAh/cm², about 300 mAh/cm², about 325 mAh/cm², about 350 mAh/cm², about 375 mAh/cm², about 400 mAh/cm², about 425 mAh/cm², about 450 mAh/cm², and about 475 mAh/cm². In yet still further aspects, the current density can have any value between any two foregoing values. In still further aspects, the power source is configured to provide a desired voltage between the cathode and anode material. In such aspects, the provided voltage can be from about 0.5 V to about 10 V, including exemplary values of about 1 V, about 1.5 V, about 2 V, about 2.5 V, about 3 V, about 3.5 V, about 4 V, about 4.5 V, about 5 V, about 5.5 V, about 6 V, about 6.5 V, about 7 V, about 7.5 V, about 8 V, about 8.5 V, about 9 V, and about 9.5 V. It is understood that any voltage having a value between any two foregoing values can be used to achieve the desired outcome.

In still further aspects, any known in the art cathode and anode materials can be used in the disclosed unit. For example, the cathode can comprise a Pt group metal or their alloys based electrode, a Ni-and its alloys-based electrode, a NiFe-based electrode, a NiTi-based electrode, a steel-based electrode, transition metal sulfates-based electrode, such as for example, and without limitations, molybdenum sulfide, tungsten sulfide, transition metal phosphide-based electrode, for example, and without limitations cobalt phosphide, Fe-based catalysts, carbon-based materials, or any combination thereof. In still further aspects, any cathode materials capable of inducing an electrochemical generation of hydrogen can be used.

In still further aspects, any anodes known in the art and suitable for the desired operation can be utilized. In certain aspects, the anode can comprise a gas diffusion layer. Yet in further aspects, the anode further comprises a hydrogen oxidation catalyst layer. It is understood that the gas diffusion layer assists with maintaining a stable gas-liquid interface. It is further understood that other configurations capable of maintaining a stable gas-liquid interface other than the disclosed herein gas diffusion layer can be used. For example, the stable gas-liquid interface can be formed by continuous bubbling of the gas through the second channel of the second compartment.

In certain aspects, the gas diffusion layer comprises a carbon-based gas diffusion layer, a fluorocarbon-based gas diffusion layer, a hydrophobic material comprising a plurality of pores, or any combination thereof. It is understood that any hydrophobic material can be utilized. In certain aspects, the layer can be made from the materials that are not inherently hydrophobic but can comprise a hydrophobic coating that provides the desired utility. In certain aspects, the gas diffusion layer comprises a carbon-based paper, a carbon-based textile, a modified carbon-based paper, a modified carbon-based textile, micro-porous PTFE membrane, mesoporous PTFE membrane, macro-porous PTFE membrane, or a combination thereof. It is understood that the term “modified” as used herein refers to the disposed desired coatings on the surfaces or any other modification of the surfaces to introduce the desired surface properties. For example, the surface can be chemically, electrochemically, physically, and/or plasma modified to increase roughness, introduce the desired chemical moieties, and the like.

In still further aspects, the hydrogen oxidation catalyst layer comprises one or more Pt group metal (PGM) or alloys thereof-based catalysts, PGM-free catalysts, and any combination thereof. In still further exemplary and unlimiting aspects, the hydrogen oxidation catalyst layer comprises one or more of Pt/C, Pd and its alloys, Au and its alloys, Ru and its alloys, transition metal oxides and their alloys, transition metal carbides and nitrides, metal-organic frameworks, carbon-supported metal atoms, hydrogenase, hydrogenase mimic compounds, hydrogenase, or any combinations thereof.

In still further aspects, to collect the current through both electrodes, current collectors are used for both anode and cathode. In some aspects, the current collector can be presented as a bipolar plate, or a wire, or a plate, or any combination thereof. For example and without limitations, the current collector/bipolar plates can be made of graphite (plain or porous), titanium, gold or gold-coated metal plates, etc.

It is also understood that any known in the art cation exchange membranes and anion exchange membranes can be used. In such aspects, any known and commercially available cation exchange membranes and anion exchange membranes can be used.

In certain aspects, the polymeric cation-exchange membranes comprise —SO₃⁻, —COO⁻, —PO₃²⁻, —PO₃H⁻, or —C₆H₄O⁻ cation exchange functional groups. The polymers for the preparation of cation-exchange membranes can be perfluorinated ionomers such as NAFION (a perfluorosulfonic-based membrane), FLEMION, and NEOSEPTA-F, partially fluorinated polymers, non-fluorinated hydrocarbon polymers, non-fluorinated polymers with aromatic backbone, or acid-base blends. It will be appreciated that in some aspects, depending on the need to restrict or allow migration of a specific cation or an anion species between the electrolytes, a cation exchange membrane that is more restrictive and thus allows migration of one species of cations while restricting the migration of another species of cations may be used as, e.g., a cation exchange membrane that allows migration of potassium ions into the cathode electrolyte while restricting migration of other cations into the cathode electrolyte, may be used. Such restrictive cation exchange membranes are commercially available and can be selected by one ordinarily skilled in the art. Some exemplary and commercially available membranes, such as Nafion®N117, CMI-7000, CMH-PP Ralex, EMION PF1-HLF8-15-X, CEM-Type I and CEM-Type II, etc., can be used.

Anion exchange membranes (AEM) are conventionally known in the art. In some aspects, the polymeric anion-exchange membranes comprise —NH₃⁺, —NRH₂⁺, —NR₂H⁺, —NR₃⁺, or —SR₂⁻ anion exchange functional groups. The polymers for the preparation of anion-exchange membranes can be perfluorinated ionomers such as NAFION (a perfluorosulfonic-based membrane), FLEMION, and NEOSEPTA-F, partially fluorinated polymers, non-fluorinated hydrocarbon polymers, non-fluorinated polymers with aromatic backbone, or acid-base blends. It will be appreciated that in some aspects, depending on the need to restrict or allow migration of a specific cation or an anion species between the electrolytes, an anion exchange membrane that is more restrictive and thus allows migration of one species of anions while restricting the migration of another species of anions may be used as, e.g., an anion exchange membrane that allows migration of chloride ions into the anode electrolyte while restricting migration of other anions into the anode electrolyte, may be used. Such restrictive anion exchange membranes are commercially available and can be selected by one ordinarily skilled in the art. In still further aspects, any known and commercially available anion exchange membranes can be used. For example, and without limitations, Sustainion® 37-50, Nafion® 115, PiperION TP-85, Fumasep FAPQ-375, PBI, Neosepta ACN, etc. In certain aspects, the unit can comprise one or more of cation exchange membranes and/or anion exchange membranes. In still further aspects, the cation and anion exchange membranes can be unsupported. While in other aspects, the cation and anion exchange membranes can be supported or reinforced. For example, the cation and/or anion exchange membranes can be polymer reinforced. In such aspects, the polymers that are used for reinforcement are inert to the first, second, and/or third electrolyte solutions present in the disclosed units. In still further aspects, the cation and/or anion exchange membranes can be PTFE-reinforced, PEEK reinforced, or any combination thereof.

In still further aspects, the cation and anion exchange membranes can have any desired thickness. In some aspects, the thickness of the membranes can be about 15 μm to about 450 μm, including exemplary values of about 20 μm, about 30 μm, about 40 μm, about 50 μm, about 60 μm, about 70 μm, about 80 μm, about 90 μm, about 100 μm, about 150 μm, about 200 μm, about 250 μm, about 300 μm, about 350 μm, and about 400 μm.

In still further aspects, the flow of the first electrolyte, the second electrolyte, and/or the third electrolyte can be the same or different and can be determined based on the specific application. In certain aspects, the first electrolyte, the second electrolyte, and/or the third electrolyte can have a flow rate from about 1 to about 5,000,000 mL/h, including exemplary values of about 50 mL/h, about 100 mL/h, about 200 mL/h, about 300 mL/h, about 400 mL/h, about 500 mL/h, about 600 mL/h, about 700 mL/h, about 800 mL/h, about 900 mL/h, about 1,000 mL/h, about 5,000 mL/h, about 10,000 mL/h, about 50,000 mL/h, about 100,000 mL/h, about 250,000 mL/h, about 500,000 mL/h, about 750,000 mL/h, about 1,000,000 mL/h, about 2,000,000 mL/h, about 3,000,000 mL/h, and about 4,000,000 mL/h. It is also understood that the flow rate can have any value between any two foregoing values.

In still further aspects, the electro-synthesizer unit disclosed herein can produce the acid solution and the base solution at any desired pH. For example, the unit disclosed herein can produce the acid and base solutions at low concentrations. For example, when the pH in the first compartment is about 8 to about 14.5, including exemplary values of about 8.5, about 9, about 9.5, about 10, about 10.5, about 11, about 11.5, about 12, about 12.5, about 13, about 13.5, and about 14, and wherein the pH in the second compartment is about −0.5 to about 6, including exemplary values of 0, about 0.5, about 1, about 1.5, about 2, about 2.5, about 3, about 3.5, about 4, about 4.5, about 5, and about 5.5, the base solution removed from the one or more outlets of the first compartment and the acid solution removed from the outlet of the second compartment has a molarity of greater than 0 to less than about 3 M, including exemplary values of about 0.001 M, about 0.005 M, about 0.01 M, about 0.05 M, about 0.1 M, about 0.5 M, about 1 M, about 1.5 M, about 2 M, and about 2.5. It is understood that these values are only exemplary, and the base solution and acid solution can be present in a concentration having any values between any two foregoing values. Similarly, the first and second compartments can have pH values falling between any two foregoing values. It is further understood that in some aspects, the generated acid solution and the generated base solution can have substantially the same concentration. While in other aspects, the generated acid solution and the generated base solution can have a different concentrations falling with the disclosed values.

In further aspects, when the pH in the first compartment is about 8 to about 15.5, including exemplary values of about 8.5, about 9, about 9.5, about 10, about 10.5, about 11, about 11.5, about 12, about 12.5, about 13, about 13.5, about 14, about 14.5, and about 15, and wherein the pH in the second compartment is about 1 to about 6, including exemplary values of about 1.5, about 2, about 2.5, about 3, about 3.5, about 4, about 4.5, about 5, and about 5.5, the base solution removed from the one or more outlets of the first compartment has a molarity of greater than 0 to about 20 M, including exemplary values of about 0.001 M, about 0.005 M, about 0.01 M, about 0.05 M, about 0.1 M, about 0.5 M, about 1 M, about 2 M, about 3 M, about 4 M, about 5 M, about 6 M, about 7 M, about 8 M, about 9 M, about 10 M, about 12 M, about 13 M, about 14 M, about 15 M, about 16 M, about 17 M, about 18 M, and about 19 M. It is understood that these values are only exemplary, and the base solution can be present in a concentration having any values between any two foregoing values.

In further aspects, when the pH in the first compartment is about 8 to about 15.5, including exemplary values of about 8.5, about 9, about 9.5, about 10, about 10.5, about 11, about 11.5, about 12, about 12.5, about 13, about 13.5, about 14, about 14.5, and about 15, and wherein the pH in the second compartment is about 1 to less than about 6, about 1.5, about 2, about 2.5, about 3, about 3.5, about 4, about 4.5, about 5, and about 5.5, the acid solution removed from the outlet of the second compartment has a molarity of greater than 0 to about 10 M, including exemplary values of about 0.001 M, about 0.005 M, about 0.01 M, about 0.05 M, about 0.1 M, about 0.5 M, about 1 M, about 2 M, about 3 M, about 4 M, about 5 M, about 6 M, about 7 M, about 8 M, and about 9 M. It is understood that these values are only exemplary, and the acid solution can be present in a concentration having any values between any two foregoing values.

Similarly, the first and second compartments can have pH values falling between any two foregoing values. It is further understood that in some aspects, the generated acid solution and the generated base solution can have substantially the same concentration. While in other aspects, the generated acid solution and the generated base solution can have a different concentrations falling with the disclosed values.

In still further aspects, the electro-synthesizer unit is a recirculated-in-a-loop system. In still further aspects, the electro-synthesizer unit can be connected to one or more pumps. It is understood that in some aspects, the desired flow of the electrolytes and other streams can be provided by any means known in the art. In some aspects, one or more pumps are used to deliver the desired stream. While in other aspects, pumps are not used. It is understood that any known in the art pumps can be utilized.

In still further aspects, if desired the disclosed herein one or more electro-synthesizer units can be driven by different cathodic and anodic reactions including but not limited to hydrogen oxidation reaction (HOR), hydrogen evolution reaction (HER), oxygen evolution reaction (OER), oxygen reduction reaction (ORR).

In still further aspects, the disclosed herein electro-synthesizer unit can be in communication with a controller. The controller can comprise a processor that allows control of the desired process. In some aspects, the controller is a feedback loop base controller designed to adjust processing conditions based on an output. In still further aspects, the power source used to operate the disclosed herein electro-synthesizer unit can be a conventional grid power source, a renewable power source or any combination thereof. In still further aspects, the electro-synthesizer unit can be designed to work during the off-peak time to allow energy savings.

In still further aspects, the electro-synthesizer unit disclosed herein has a coulombic efficiency of greater than about 80%, about 85%, about 90%, about 95%, and 100%. In still other aspects, the electro-synthesizer unit disclosed herein exhibits a coulombic efficiency of substantially 100%.

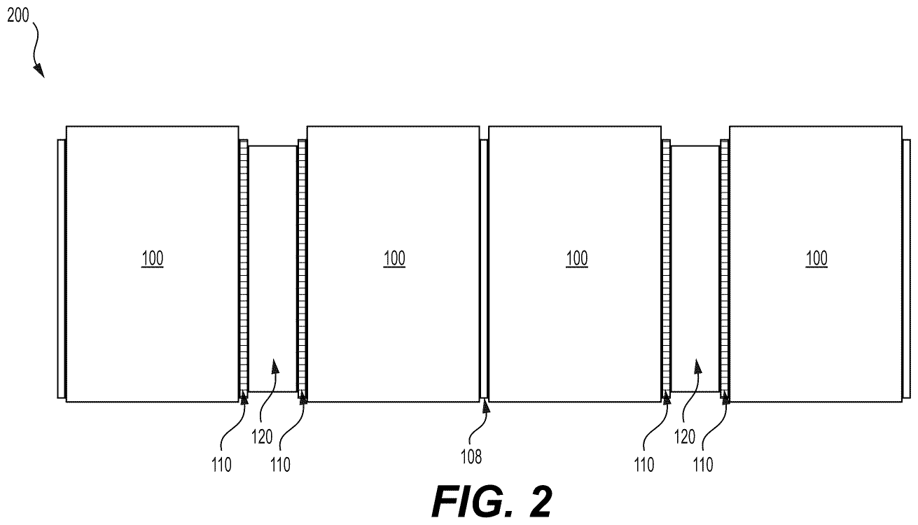

Also disclosed herein are systems comprising one or more of the electro-synthesizer units disclosed herein. The exemplary system 200 is shown in FIG. 2 and comprises 4 different electro-synthesizer units 100 as described above. In certain aspects, wherein two or more electro-synthesizer units are present, these two or more electro-synthesizer units are designed to share a cathode 108. Yet in other aspects, when three or more electro-synthesizer units are present, these three or more electro-synthesizer units are configured to share the second channel 120 of the second compartment.

In still further aspects, the system can comprise from 1 to about 1000, including exemplary values of 2, 3, 5, 10, 15, 20, 30, 50, 100, 250, 500, and 750 of electro-synthesizer units. It is understood that there is actually no limit to the number of electro-synthesizer units present in the system. For example and without limitations for a 100 cm² electro-synthesizer (total effective area=2500 cm²), one can utilize 25-electro-synthesizer units. In other exemplary and unlimiting aspects, for a 400 cm² electro-synthesizer (total effective area=16000 cm²), one can utilize 40-electro-synthesizer units.

### System for Carbon Capture

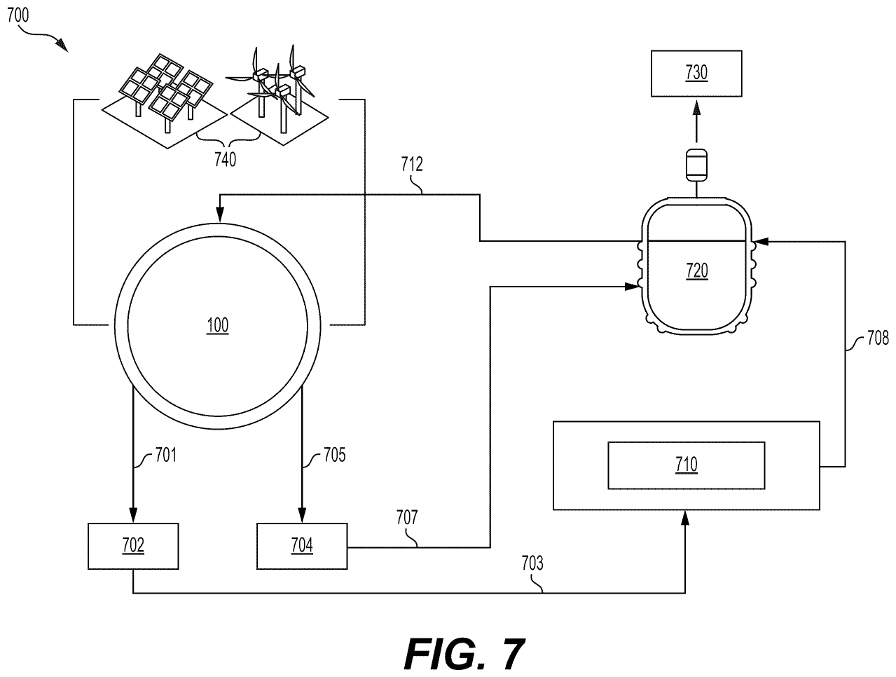

Still further disclosed herein is a system comprising one or more flow electro-synthesizer units disclosed above, wherein each unit is configured to produce an acid solution and a base solution; one or more carbon dioxide capturing apparatuses that is in fluid communication with the one or more flow electro-synthesizer units and that are configured to capture a carbon dioxide from a gas source by converting the carbon dioxide to a bicarbonate solution, carbonate solution, or a combination thereof. An exemplary system 700 is shown in FIG. 7. The at least one unit 100 is in communication with a power source 740. Any of the disclosed power sources can be used for this system. The system is in fluid communication with the one or more carbon dioxide-capturing apparatuses 710.

The one or more electro-synthesizer units 100 in system 700 can have any of the disclosed first, second and/or third electrolyte solutions. For example and without limitations, the first electrolyte solution can comprise any of the disclosed above bases and/or one or more inorganic salts in any of the disclosed above concentrations. In still further aspects, the second electrolyte solution can comprise any of the disclosed above acids and/or one or more inorganic salts in any of the disclosed above concentrations. Similarly, the third electrolyte solution can comprise any of the disclosed above one or more inorganic salts in any of the disclosed above concentrations.

It is further understood that the electrolytes can be delivered at any of the disclosed above flow rates. In some aspects, all three electrolytes have the same flow rate. In other aspects, each of the electrolytes has a different flow rate. While in still further aspects, some of the electrolytes can be delivered at the same flow rates while others can have a different flow rate.

As disclosed above, in some aspects, the generated in the first compartment base solution can be the same or different from the first electrolyte. In other aspects, the generated in the second compartment acid solution can be the same or different as the second electrolyte. Still, in further aspects, the one or more inorganic salts in the first electrolyte are the same or different from the one or more inorganic salts in the second and/or third electrolytes. While in other aspects, the one or more inorganic salts in the second electrolyte are the same or different from the one or more inorganic salts in the first and/or third electrolytes. While in still further aspects, the one or more inorganic salts in the third electrolyte are the same or different as the one or more inorganic salts in the first electrolyte and/or second electrolyte.

Again as disclosed above, the second compartment is configured to receive a hydrogen stream to be oxidized on the anode to produce the acid solution, wherein the hydrogen stream comprises the hydrogen gas formed in the first compartment, a hydrogen provided from an external source, or a combination thereof.

In still further aspects, at least a portion of the base solution formed in the first compartment 702 is withdrawn from the unit and is fed by line 703 to the one or more carbon dioxide-capturing apparatuses. It is understood that any known in the art capturing apparatuses can be used. For example and without limitations, any commercial carbon dioxide contactors can be utilized. In some exemplary and unlimiting aspects, the air contactor comprises the system described in co-pending U.S. Provisional Patent Application No. 63/370,260, filed on Aug. 3, 2022, in the name of Chao Wang and Yulin LIU and entitled “Efficient Liquid-Air Contactor in Parallel Flow Configuration,” which is hereby incorporated by reference herein in its entirety. Briefly, the at least one air contactor disclosed in the 63/370,260 application comprises an air contactor membrane module that comprises a housing and a plurality of membranes within said housing. The plurality of membranes comprising modified polypropylene creates a barrier separating a gas phase from a liquid phase. The polypropylene material of the membranes comprises pores such that specific molecules in the gas phase can diffuse through the membrane and into the liquid phase to react with the liquid phase. The surface of the membranes is designed to be substantially hydrophobic, effectively preventing water molecules from entering the gas phase. However, this specific contactor is exemplary, and any other known contactor can be used for the desired purpose.

The captured carbon dioxide reacts with the base solution to form a bicarbonate solution, carbonate solution, or a combination thereof. In still further aspects, the one or more carbon dioxide capturing apparatuses captures CO₂ and generates a gas that comprises less than about 200 ppm of carbon dioxide, less than about 100 ppm of carbon dioxide, less than about 50 ppm of carbon dioxide, or less than about 10 ppm of carbon dioxide. In yet still further aspects, the generated gas is substantially free of carbon dioxide.

It is understood that carbon dioxide can be captured from any gas. For example, and without limitations, the gas, directed towards one or more carbon dioxide-capturing apparatuses, can comprise ambient air, industrial gas source, substantially high concentration carbon dioxide, or any combination thereof. In still further aspects, the gas source is the ambient air. In other aspects, the gas source is the industrial gas source. In still further aspects, the gas source is a substantially high concentration of carbon dioxide. It is understood that the ambient air includes indoor and outdoor air. In still further aspects, it is understood that industrial gas sources include any waste gas stream, any gas stream that is a by-product of any manufacturing processes, or a by-product of any industrial processes. In some aspects, the gas source is obtained from various industrial sources that release carbon dioxide, including carbon dioxide from combustion gases of fossil-fueled power plants, e.g., conventional coal, oil and gas power plants, or IGCC (Integrated Gasification Combined Cycle) power plants that generate power by burning syngas; cement manufacturing plants that convert limestone to lime; ore processing plants; fermentation plants; and the like. In some aspects, the gas source may comprise other gases, e.g., nitrogen, oxides of nitrogen (nitrous oxide, nitric oxide), sulfur and sulfur gases (sulfur dioxide, hydrogen sulfide), and vaporized materials.

In some aspects, the gas source is scrubbed or otherwise treated to remove at least a portion of gases other than carbon dioxide prior to flowing into the carbon dioxide-capturing apparatus. Yet, in other aspects, the gas source is untreated prior to being flown into the carbon dioxide-capturing apparatus.

In still further aspects, the system can further comprise one or more neutralizers 720. As can be seen in FIG. 7, the one or more neutralizers 720 are in fluid communication with the one or more carbon dioxide gas capturing apparatuses 710 and one or more flow electro-synthesizer units 100. In still further aspects, at least the second compartment (not shown in FIG. 7) of the one or more flow electro-synthesizer units 100 is in fluid communication (705 and 707) with the one or more neutralizers 720. In such aspects, at least a portion 704 of the acid solution formed in the second compartment is withdrawn from unit 100 by line 705 and fed into the one or more neutralizers 720. It is understood that this step is aimed to neutralize at least a portion of the base solution that is fed into the one or more carbon dioxide-capturing apparatuses and then fed into one or more neutralizers together with the precipitated oxides, hydroxides, bicarbonates, carbonates, or any combination thereof, by line 708 into the neutralizer 720. In still further aspects, if desired, the one or more neutralizers can comprise mixing means.

In still further aspects, the one or more neutralizers 720 are configured to react the at least a portion of the acid solution with the at least a portion of the base solution to form a salt, which can then be directed to the third compartment of unit 100 by the line 712. In such aspects, the salt is fed into the third compartment of the one or more flow electro-synthesizer units and becomes at least a portion of the third electrolyte. It is understood that the at least a portion of the acid also reacts with the precipitated oxides, hydroxides, bicarbonates, carbonates, or any combination thereof. In still further aspects, a substantially high concentration of carbon dioxide can also be formed in the one or more neutralizers. The substantially high concentration of carbon dioxide 730 can be collected and used for any desired purpose.

In still further aspects, it is understood that at least a portion of the third electrolyte solution comprises the salt formed in the one or more neutralizers, and wherein the salt is the same or different from one or more inorganic salts present in the third electrolyte. The flow rate of each stream can have any value of the disclosed above flow rates.

In still further aspects, it is understood that the one or more flow electro-synthesizer units generate the acid solution and the base solution in a batch or a continuous operation. In yet still further aspects, the one or more flow electro-synthesizer units generate the acid solution and the base solution utilizing an energy source configured to operate continuously or on demand. For example, in some aspects, the flow electro-synthesizer units can utilize off-peak periods when the energy is cheap. In such exemplary and unlimiting aspects, the flow electro-synthesizer units can be stopped when energy is expensive and operate only when energy is cheap. In certain aspects, the generated acids/bases can be utilized immediately. While in other aspects, the generated acids/bases can be collected for further desired applications. In yet still further aspects, other parts of the system, for example, the carbon capturing apparatus and/or the one or more neutralizers, operate continuously without interruptions.

In some aspects, once in operation, the system is a recirculated-in-a-loop system that requires only a gas source feed. CO₂ in the air can be continuously captured, and the output is a high-concentration CO₂ flow. During the whole process, no additional chemicals are consumed. The regeneration of acids and bases is achieved through salt splitting. In some aspects, if desired, the system can further comprise a heat exchanger. In some embodiments, the heat exchanger comprises a recirculation-based system. This heat exchanger can be beneficial if the various parts of the system operate at different energy consumptions. For example, the one or more carbon dioxide capturing devices operate endothermically, while the one or more neutralizers operate exothermically, thus, the heat exchanger can reduce the energy usage associated with the operation of the system disclosed herein.

The system can be controlled by any controllers, as disclosed above.

### Mining Systems

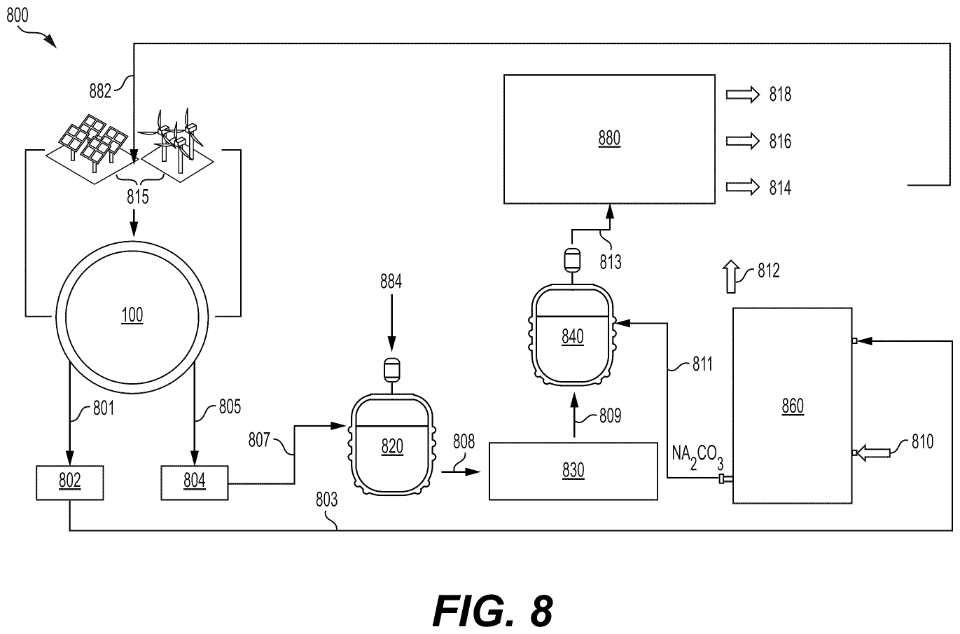

Also disclosed herein are systems that can be utilized for mining purposes. One exemplary aspect is shown in FIG. 8. This example discloses a system 800 comprising any of the abovementioned flow electro-synthesizer units 100 that are configured to produce an acid solution and a base solution. The system further comprises one or more carbon dioxide capturing apparatuses 860 that is in fluid communication with the one or more flow electro-synthesizer units 100 and that are configured to capture carbon dioxide from a gas source by converting the carbon dioxide to a bicarbonate solution, carbonate solution, or a combination thereof. The exemplary carbon dioxide-capturing apparatuses are disclosed above. The system further comprises one or more acid leachers 820 that are in fluid communication with the one or more flow electro-synthesizer units 100. The one or more acid leachers 820 are configured to receive a mineral ore 884 comprising one or more metal minerals. The acid leacher is configured to one or more solubilized minerals 830. The system further comprises one or more precipitators 880 that are in fluid communication with the one or more acid leachers 820 and with the one or more carbon dioxide capturing apparatuses 860 and that are configured to precipitate 880 at least a portion of the one or more solubilized minerals.

It is understood that any of the disclosed above flow electro-synthesizer units can be used in this system. In some aspects, the at least a portion of base 802 solutions formed in the first compartment of the unit 100 is withdrawn with line 801 and is delivered by line 803 to the carbon dioxide capturing apparatuses 860. The one or more carbon dioxide capturing apparatuses 860 are configured continuously to receive carbon dioxide gas from a gas source 810. Any of the disclosed above gas sources can be utilized. At least a portion of the bicarbonates or carbonates formed in the one or more carbon dioxide capturing apparatuses 860 is then transferred to the one or more precipitators 840 by exemplary line 811.

In still further aspects, at least a portion of the acid formed in the second compartment of the unit 100, acid solution 804 is withdrawn by line 805 and flown into one or more acid leachers 820. The acid leachers comprise the mined mineral ore 884. The acid solution dissolves the ore minerals to form solubilized minerals 830 that are then transferred to the one or more precipitators 840, as shown by lines 808 and 809. In the one or more precipitators, the solubilized minerals react with the bicarbonates and/or carbonates, formed in the one or more carbon dioxide capturing apparatuses and with the remaining base delivered to the first compartment and are precipitated 880. The precipitated minerals that can be in the form of oxides, hydroxides, bicarbonates, carbonates, or any combination thereof, can then be utilized, for example, and without limitations as economic ores and/or as carbon sequestration substrates. Yet in still further aspects, additional inorganic soluble salts can also be formed in the one or more precipitators, and such salts can be then moved to the electro-synthesizer unit to the third compartment 815 as a portion of the third electrolyte.

It is understood that the unit 100 can be operated by any of the disclosed above power sources 882.

In still further aspects, the mineral ore can be any mined ore. In some aspects, the mineral ore can include any ores, tailings, rocks containing target minerals, or any combination thereof. In some aspects, the mineral ore can comprise olivine, brucite, serpentine and chalcopyrite. Any desired minerals can be first solubilized and then precipitated as described. In still further aspects, the mineral ores disclosed herein can comprise alkaline-earth metals, Group III metals, transition metals, rare-earth minerals, or any combination thereof. The precipitates can comprise oxides, hydroxides, bicarbonates, carbonates, or any combination thereof.

For example, the mineral ores can comprise Be, Mg, Ca, Sr, Ba, Al, Ga, In, Sc, Ti, V, Cr, Mn, Fe Co, Ni, Cu, Zn, Y, Zr, Nb, Mo, Tc, Ru, Rh, Pd, Ag, Cd, Re, Os, Ir, Pt, Au; and Rare Earth Elements.

Exemplary and unlimiting minerals can comprise Mn, Co, Ni, Cu, Mg, and Fe. In still further aspects, precipitates of Mn, Co, Ni, and Cu can be reformed into economic ores that can be supplied to refineries. While in other aspects, precipitates of Mg and Fe can be remineralized for carbon sequestration. It is understood that Mg and Fe can precipitate as MgCO₃ and/or Mg(OH)₂ and/or MgO, or Fe₂(CO₃)₃ and/or FeCO₃ and/or Fe(OH)₂ and/or Fe(OH)₃ and/or Fe₂O₃ and/or FeO. In some aspects, the Mg and Fe precipitates can be used as natural weathering materials configured to adsorb more CO₂. While in other aspects, Fe precipitates can also be used as a desired product and not for sequestration.

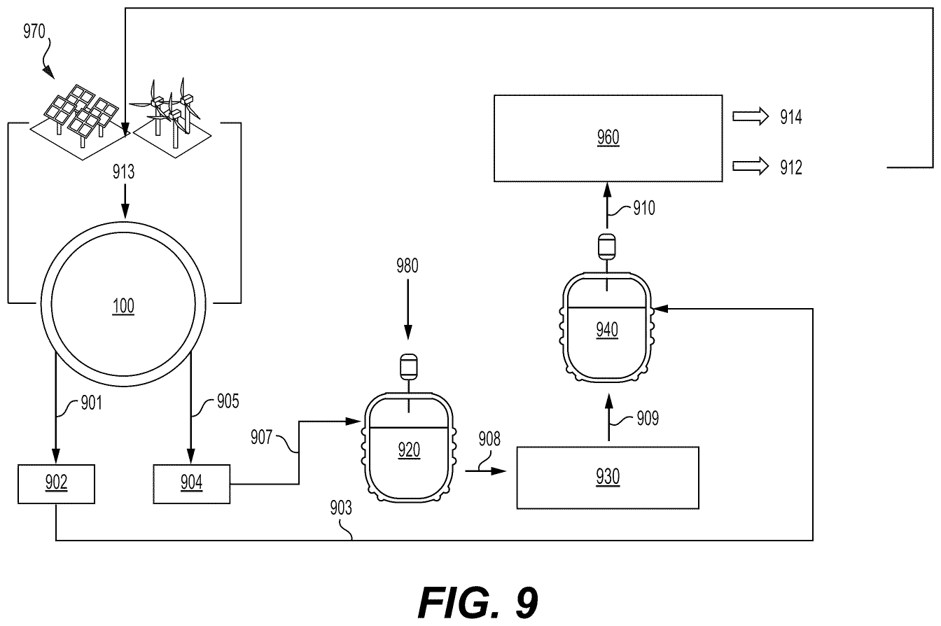

Also, in addition, or in the alternative, disclosed herein is a system 900 (FIG. 9) comprising any of the disclosed herein flow electro-synthesizer units 100 configured to produce an acid solution and a base solution. The system can further comprise one or more acid leachers 920 that are in fluid communication with the one or more flow electro-synthesizer 100. Mineral ores comprising one or more metal minerals 980 can be disposed into the one or more acid leachers 920 and form one or more solubilized minerals 930 that can be then withdrawn and moved to one or more enrichers 940 by lines 908 and 909. The one or more enrichers 940 are in fluid communication with the one or more acid leachers 920 and with the one or more flow electro-synthesizer units 100 and are configured to form an enriched mineral ore 960. At least a portion of the base solution 902 is withdrawn (901) from the unit 100 and directed (903) to the one or more enrichers 940. At least a portion of the acid solution 904 is withdrawn (905) from the unit 100 and directed (907) to the one or more acid leachers 920.

In some aspects, at least a portion of the one or more solubilized minerals 930 from the one or more acid leachers are fed (909) into the one or more enrichers 940. In still further aspects, at least a portion of the enriched minerals is collected 914. In yet still further aspects, a salt formed from a reaction between the acid solution and base solution 912 is directed back 913 to the third compartment of the one or more flow electro-synthesizer units to be used as a part of the third electrolyte.

In such aspects, the precipitation of the desired minerals is done with base solution titration. It is understood that the different metals will precipitate out at different pH values, allowing for the separation of the target elements and the production of high-grade materials comprising the target elements that can be fed to downstream refineries.

It is further understood that disclosed herein lines are only exemplary and only shown to demonstrate communication between different system elements. It is understood that different types and numbers of lines can be used in each system as desired.

In still further aspects, if desired, any of the disclosed parts of the system can also comprise means for mixing at the desired speed. In still further aspects, any parts of the disclosed herein systems are rated to withstand the reaction environment of very high and very low pHs. In some aspects, the parts of the system can be in communication with a filtration unit that permits the separation of the precipitated oxides, hydroxides, bicarbonates, carbonates, or any combination thereof, from the solution, wherein the remaining solid can be disposed of as understood by the person skilled in the art.

### Methods

Also disclosed herein are methods of producing acid and base solutions. The methods disclosed herein comprise providing the electro-synthesizer unit of any examples herein or the system of any examples herein; flowing the first electrolyte, the second electrolyte, and the third electrolyte; generating a hydrogen gas stream and a hydroxide on the cathode in the first compartment; generating hydrogen ions on the anode in the second compartment; directing a stream comprising a hydrogen gas into the second compartment; wherein the hydrogen gas present in the stream is the generated hydrogen gas and/or a hydrogen gas provided from an external source; collecting a generated base solution and a generated acid solution. The generated base solution and/or generated acid solution can have any concentration disclosed above. In certain aspects, when the formed acid solution or base solution is used as the first and the second electrolyte solution, these acid and base solutions can be diluted to arrive at any desired pH for the first and the second electrolyte.

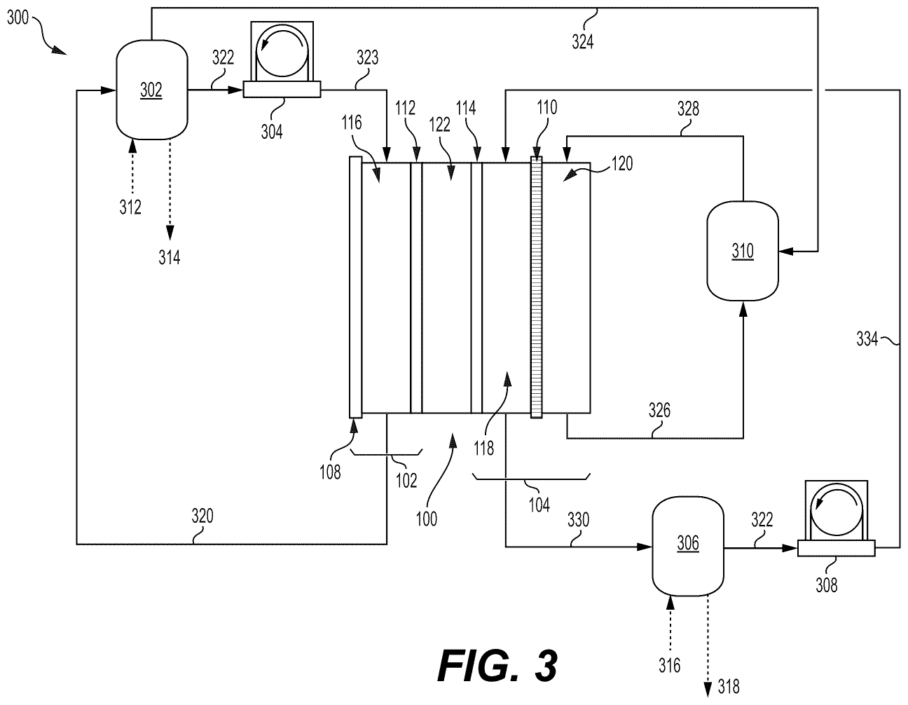

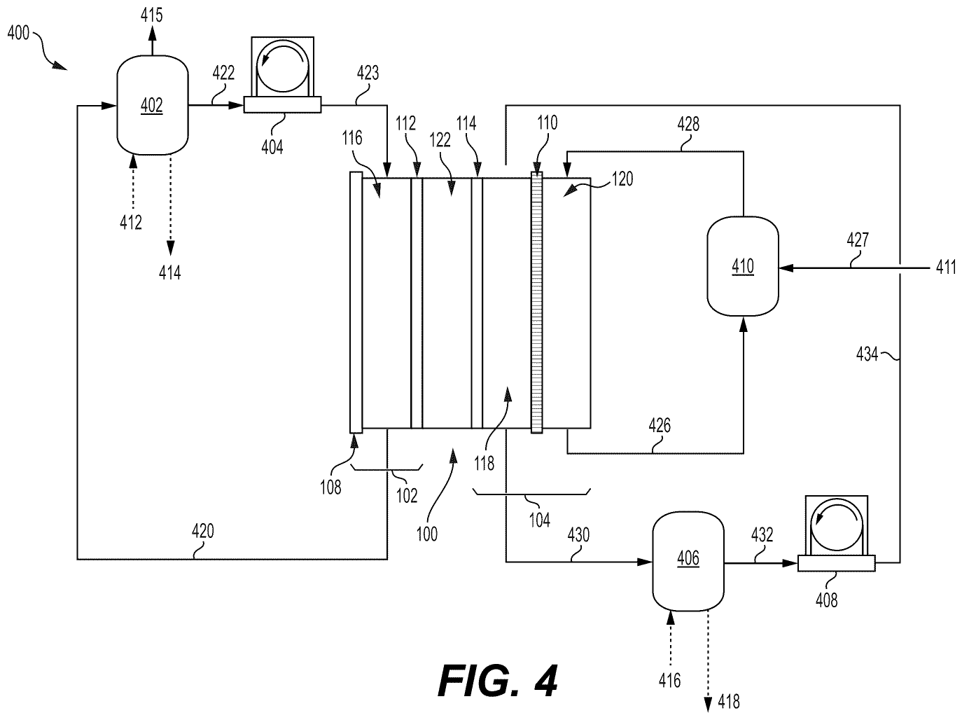

Exemplary systems of operation are shown in FIGS. 3 and 4. For example, FIG. 3 shows that system 300 is a recirculated-in-a-loop system designed to produce high-concentration acid and base solutions using the described herein electro-synthesizer unit 100. The base solution formed in the first compartment 102 is directed from the outlet by line 320 to reservoir 302, configured to collect the formed base solution. At least a portion of the collected base solution is removed by line 314. If needed, the remaining portion of the collected base solution in reservoir 302 can be diluted with water in line 312. The diluted remaining base solution is recirculated into the first compartment by lines 322 and 323 using a pumping device 304.

A hydrogen gas produced in the first compartment can also be removed from the first compartment using line 320. In some aspects, the hydrogen gas can be removed by a separate line (not shown). In certain aspects, the generated hydrogen gas can be moved to reservoir 302, separated from the base solution, and delivered to hydrogen reservoir 310. In certain aspects, the generated hydrogen can be moved out of the first compartment by a separate line and directly communicated to the hydrogen reservoir (not shown). Hydrogen from the hydrogen reservoir can be delivered by line 328 to the second channel 120 of the second compartment and recirculated back by line 326 to hydrogen reservoir 310. In still further aspects, the acid solution formed in the second compartment is delivered with line 330 to an acid reservoir 306.

At least a portion of the generated acid solution can be removed by line 318. The remaining portion of the acid solution can be diluted with water by line 316. The diluted acid solution can then be recirculated into the first channel 118 of the second compartment with lines 322 and 334 using an optional pump 308. It is understood that since the electro-synthesizer unit is a flow unit, the third electrolyte in the third compartment continuously flows through the system (not shown).

FIG. 4 shows a similar setup with only a difference where the hydrogen gas formed in the first compartment is not recirculated back to the hydrogen reservoir 410. The hydrogen reservoir 410 is configured to receive a hydrogen gas from an external source 411 by line 427. Similarly to FIG. 3, the hydrogen gas stream 120 delivered to the second channel is recirculated back to the hydrogen reservoir 410 by lines 428 and 426. Line 430 collects the generated acid solution and delivers it to acid reservoir 406, where at least a portion of the acid solution is removed by line 418, and the remaining portion is diluted with water by line 416. The diluted acid solution is then recirculated back to the first channel 118 of the second compartment with lines 432 and 434 using optional pump 408.

The generated base solution is removed from the first compartment by line 420 and delivered to a base reservoir 402. A generated hydrogen gas is removed from the reservoir by line 415, and at least a portion of the generated base is removed by line 414. The remaining portion of the generated base is diluted by line 412 and delivered back to the first compartment as the first electrolyte by lines 422 and 423 using an optional pump 404.

Still further disclosed herein is a method of directly capturing carbon dioxide from a gas source, wherein the method comprises: providing any of the disclosed herein systems comprising one or more disclosed herein flow electro-synthesizer units, electrochemically generating a hydrogen gas and hydroxide ions on the cathode in the first compartment; flowing a stream comprising a generated hydrogen gas, a hydrogen gas provided by an external source, or a combination thereof, to the second compartment, such that electrochemically generated hydrogen ions are formed on the anode; directing a portion of the cathode electrolyte comprising the generated hydroxide ions to one or more carbon dioxide capturing apparatuses configured to capture a carbon dioxide from a gas source by converting the carbon dioxide to a bicarbonate solution, carbonate solution, or a combination thereof. In still further aspects, the method further comprises directing the bicarbonate solution, carbonate solution, or a combination thereof to one or more neutralizers that is in fluid communication with the one or more carbon dioxide capturing apparatuses. Any of the disclosed above carbon dioxide capturing devices and neutralizers can be used in the methods.

Still further disclosed herein are methods providing any of the disclosed herein systems comprising one or more of the disclosed herein flow electro-synthesizer units, electrochemically generating a hydrogen gas and hydroxide ions on the cathode in the first compartment; flowing a stream comprising a generated hydrogen gas, a hydrogen gas provided by an external source, or a combination thereof, such that electrochemically generated hydrogen ions are formed on the anode; directing a portion of the cathode electrolyte comprising the hydroxide ions to one or more carbon dioxide capturing apparatuses configured to capture a carbon dioxide from a gas source by converting the carbon dioxide to a bicarbonate solution, carbonate solution, or a combination thereof; directing a portion of the anode electrolyte comprising hydrogen ions to one or more acid leachers, wherein the one or more acid leachers comprise a mineral ore comprising one or more metal minerals, and forming an aqueous solution comprising one or more solubilized minerals; directing the bicarbonate solution, carbonate solution, or a combination thereof and the aqueous solution comprising one or more solubilized minerals to one or more precipitators to precipitate at least a portion of the one or more solubilized minerals. In such aspects, the one or more solubilized minerals can precipitate as oxides, hydroxides, bicarbonates, carbonates, or any combination thereof. In such exemplary aspects, the method is a carbon-negative method.

Still further disclosed herein are methods providing any of the disclosed herein systems comprising one or more of the disclosed herein flow electro-synthesizer units; electrochemically generating a hydrogen gas and hydroxide ions on the cathode in the first compartment; flowing a stream comprising a generated hydrogen gas, a hydrogen gas provided by an external source, or a combination thereof, such that electrochemically generated hydrogen ions are formed on the anode; directing a portion of the anode electrolyte comprising hydrogen ions to one or more acid leachers, wherein the one or more acid leachers comprise a mineral ore comprising one or more metal minerals, and forming an aqueous solution comprising one or more solubilized minerals; directing a portion of the cathode electrolyte comprising the hydroxide ions to the one or more enrichers, directing a portion of the aqueous solution comprising one or more solubilized minerals to the one or more enrichers forming an enriched mineral ore in the one or more enrichers. In such exemplary aspects, the method is a carbon-neutral method.

In still further aspects, the methods disclosed herein are carried out at room temperature. In still further aspects, if desired any of the disclosed herein steps can be heated to a temperature of less than or equal to about 100° C., less than or equal to about 80° C., less than or equal to about 50° C., or less than or equal to about 40° C. In some aspects, if desired the methods disclosed herein can include heat exchangers.

In still further aspects, the ores can be size-reduced and have an average size of about 5 mm to about 100 μm, including exemplary values of about 4 mm, about 3 mm, about 2 mm, about 1 mm, about 900 μm, about 800 μm, about 700 μm, about 600 μm, about 500 μm, about 400 μm, about 300 μm, about 200, and about 150 μm.

By way of a non-limiting illustration, examples of certain aspects of the present disclosure are given below.

### EXAMPLES

The following examples are put forth so as to provide those of ordinary skill in the art with a complete disclosure and description of how the compounds, compositions, articles, devices, and/or methods claimed herein are made and evaluated and are intended to be purely exemplary and are not intended to limit the disclosure. Efforts have been made to ensure accuracy with respect to numbers (e.g., amounts, temperature, etc.), but some errors and deviations should be accounted for. Unless indicated otherwise, parts are parts by weight, temperature is degrees C. or is at ambient temperature, and pressure is at or near atmospheric.

### Example 1

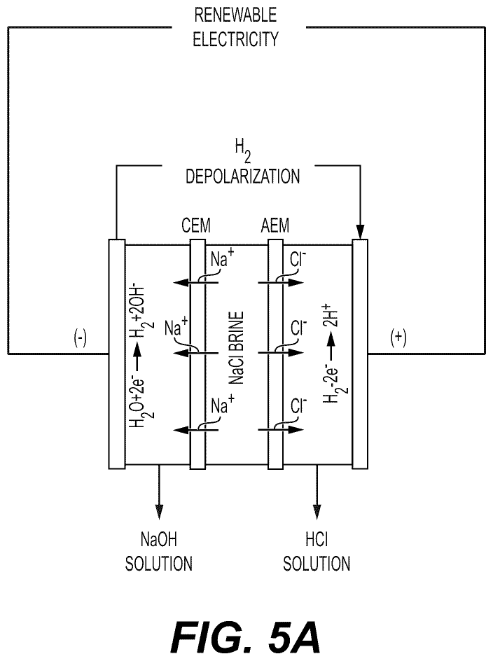

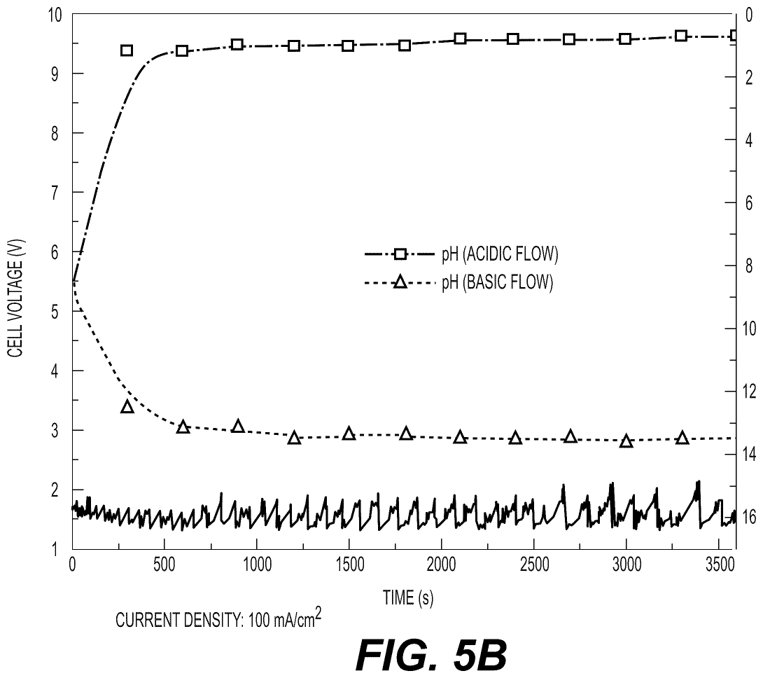

FIGS. 5A-5B shows the generation of HCl at a current density of 100 mA/cm². The schematic of the reactions is shown in FIG. 5A, and the results are shown in FIG. 5B. It can be seen that substantially stable acid and base flows are generated after less than 500 seconds from the initial cell operation. Such a stable production can be continued for about 1 hour, for about 2 hours, for about 5 hours, for about 10 hours, or even for about 24 hours if desired.

### Example 2

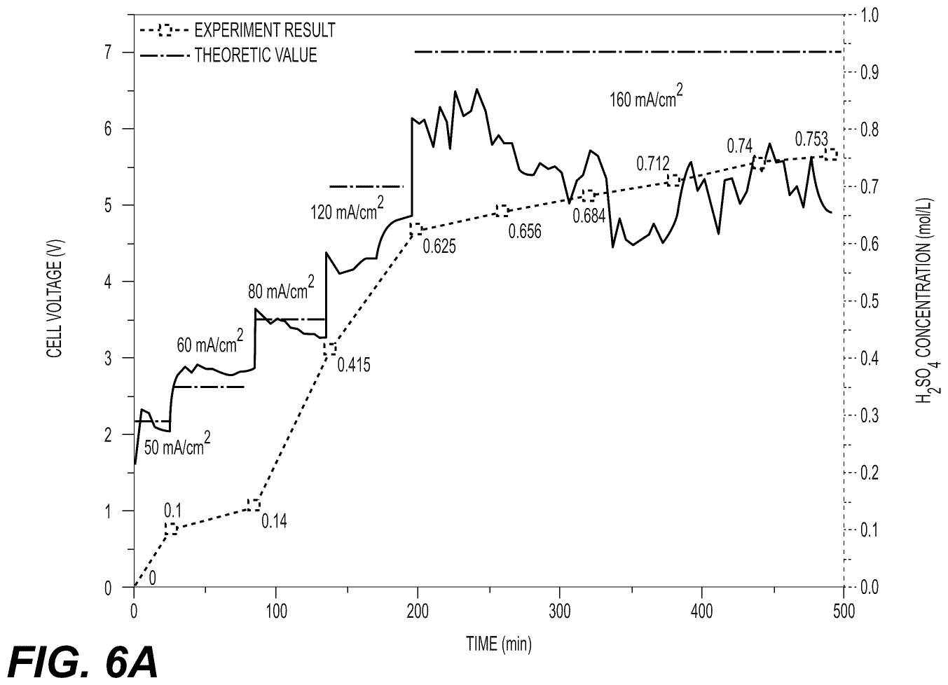

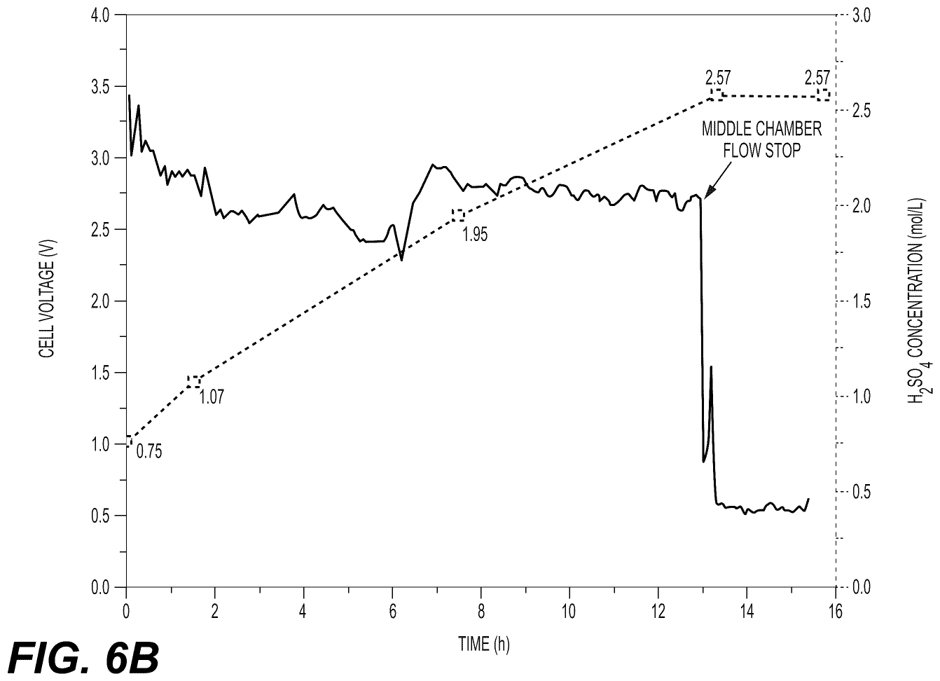

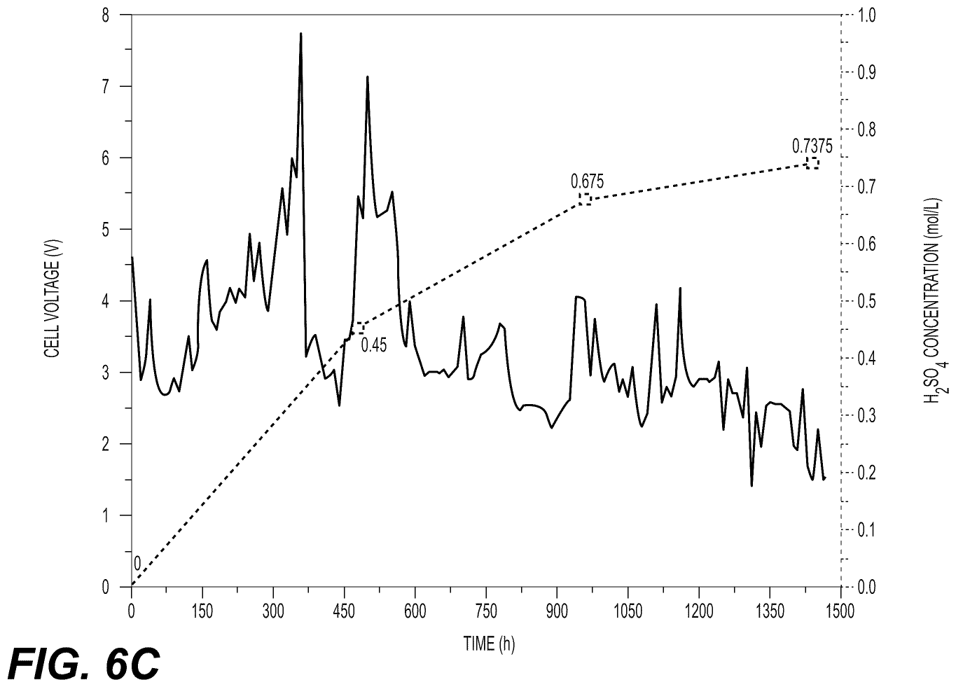

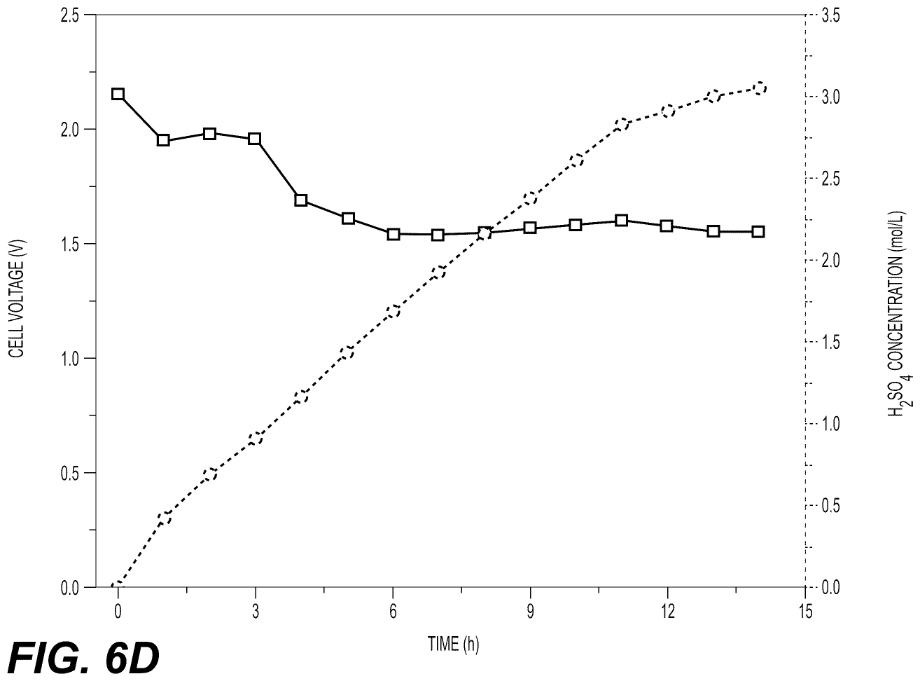

FIG. 6A shows a single pass H₂SO₄ production measured at different current densities. The plot compares experimental results and theoretical values calculated for such a process. In this example, the flow of the first and second electrolytes was not the same, 100 ml/h and 8 ml/h, respectively. FIGS. 6B-6D show results of H₂SO₄ production with solution recirculation system as disclosed herein. An exemplary desired performance of the cell is shown in FIG. 6D. In this example, 3 mol/L H₂SO₄ was synthesized by recirculating the brine solution from neutral pH with high energy efficiency (cell voltage maintained around 1.5V after the starting period). The conditions for the experiments are shown in the brief description of the drawings.

### Example 3

The disclosed herein carbon capturing system takes advantage of the ambient-condition acid-base reaction to capture and release CO₂, thus allowing a faster in kinetics with the barrierless reactions, more energy-efficient by avoiding high-temperature calcination or pressure-swing processes, and more sustainable with high compatibility with renewable (but intermittent) energy sources. All the chemicals employed in the proposed process are recyclable except the carbon/CO₂ mass flow from the air to the concentrated product. The direct air capturing system can be fully powered by electricity, allowing for high-level integration with renewable energy sources such as solar and wind.

In some examples that 0.1 M of KOH and HCl are produced at a current of 0.1 A. At least a portion of the generated KOH solution is flown to the carbon capturing apparatus, for example, the air contactor. Up to 35 liters of air can pass through the direct air capture unit every minute. The captured CO₂ reacts with KOH to form K₂CO₃ without water molecules entering the gas phase. The commercially available capturing devices allow for 50% capture efficiency. In this unlimiting example, the liquid flow rate is controlled at 100 mL per hour, resulting in a system with a maximum gas-liquid flow ratio of 21,000:1. Such a high gas-liquid flow ratio reduces the energy required to pump the liquid. The K₂CO₃ solution from the air contactor enters the neutralizer and reacts with the acid generated by the electro-synthesizer. High concentration CO₂ is released and collected in this process. In the end, the neutral KCl solution flows back to the electro-synthesizer units to realize the regeneration of the electrolyte and close the mass balance.

### Example 4

In this example, carbon-negative mining was achieved by electro-synthesizing an acid (as disclosed above) and using this acid to leach targeted critical elements out of low-grade minerals and tailings via acid-base reactions. For example, nickel contained in silicate olivines can be extracted out via reaction with electro-synthesized HCl:

(Mg,Fe,Ni)₂SiO₄+4HCl→2(Mg,Fe,Ni)Cl₂+2H₂O+SiO₂

If needed, the reaction can also be accelerated by heating to temperatures of less than about or equal to 100 (C, less than about or equal to 80 (C, less than about or equal to 50 (C, or less than about or equal to 40 (C).

Similar processes can also be applied to minerals such as brucite and serpentine. Brucite usually contains minor amounts of Cr, Mn, Co and Ni, which can be extracted via (in the instance of Co)

(Mg,Co)(OH)₂+2HCl→2(Mg,Co)Cl₂+2H₂O

In the case of serpentine with, e.g., Mn, the reaction can be described as:

(Mg,Fe,Mn)₃Si₂O₅(OH)₄+4HCl→2(Mg,Fe,Mn)Cl₂+2H₂O+SiO₂

Low-grade ores such as chalcopyrite can also be treated with HCl for extraction of the Cu via

CuFeS₂+4HCl→2(Cu,Fe)Cl₂+2H₂S

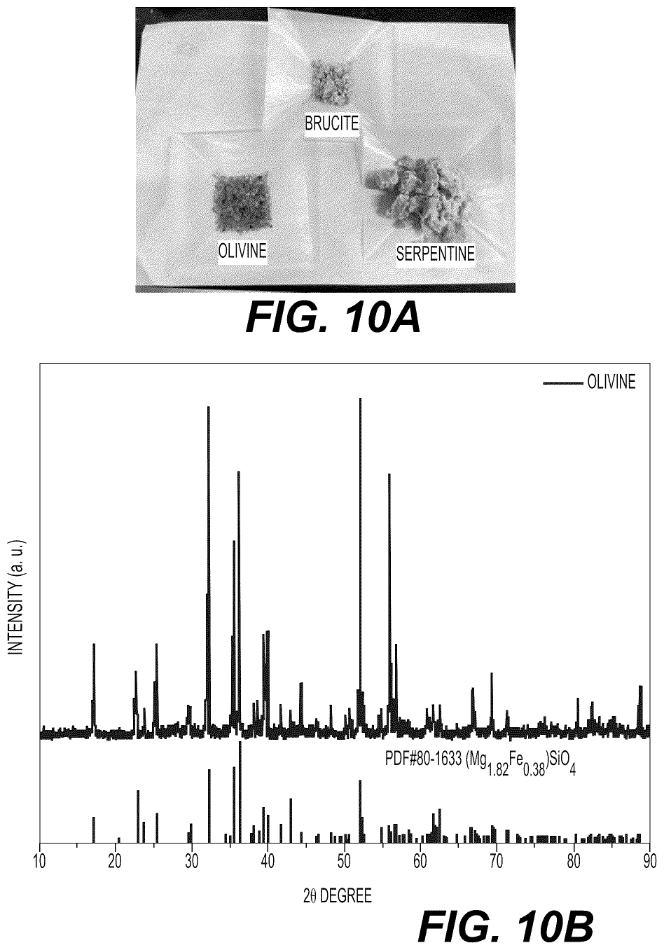

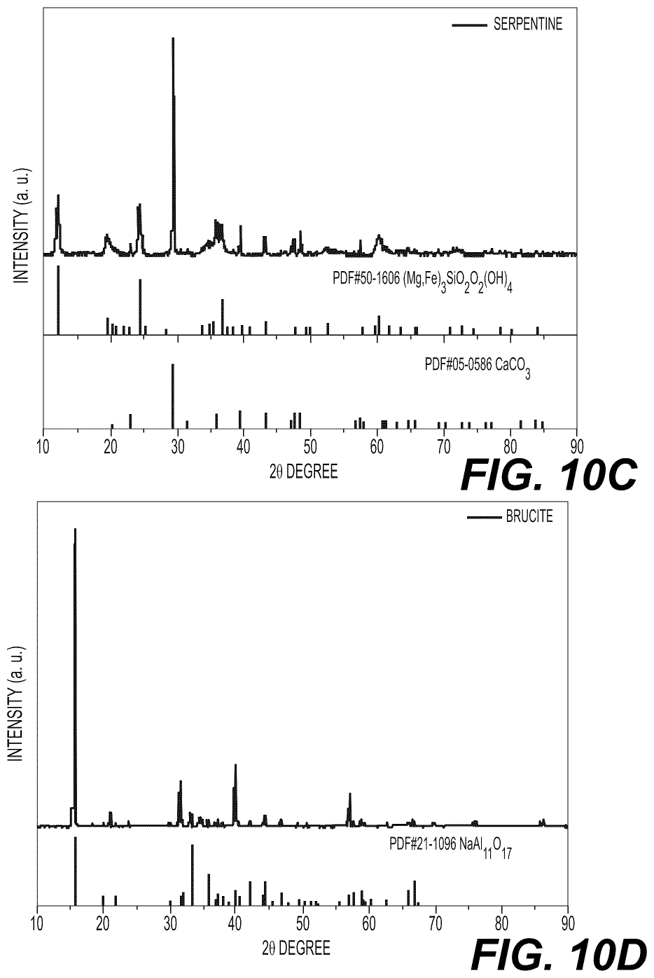

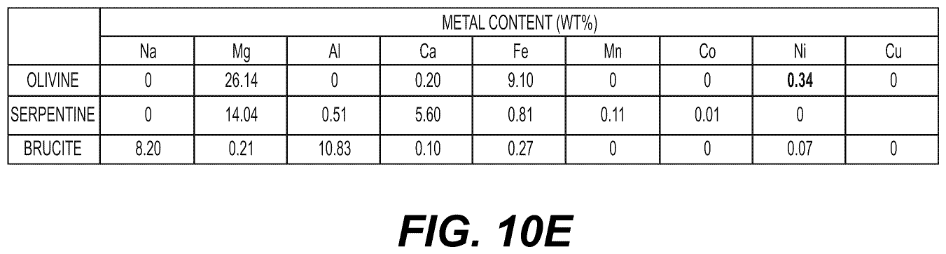

In some exemplary and unlimiting aspects, the ores can comprise gangue minerals. The exemplary ores and their chemical analysis are shown in FIGS. 10A-10E.

In some aspects, the ores can be size reduced. Any methods known in the art for size reduction can be used. In some aspects, the ores can be pulverized to increase the surface area exposed to the acid. In some aspects, the ores are classified as coarse. In some aspects, the ores are classified as fine. In some aspects, the ores can pass through one of the ASTM E11 sieves selected from No. 4 (4.75 mm) (coarse), No. 8 (2.36 mm) (fine), No. 16 (1.18 mm) (fine), No. 30 (600 μm) (fine), No. 50 (300 μm) (fine), or No. 100 (150 μm) (fine).

The proposed acid leaching process mitigates the mass transfer limitation for the leachant (in the case of CO₂ from air) and, more importantly, has substantially accelerated kinetics by conducting the reaction at low pH. This feature is expected to reduce the extent of crushing and milling needed for efficient leaching and thereby lower the energy consumption for beneficiation. The various metal chlorides produced from the above reactions can be subjected to carbonation reactions to precipitate as metal carbonate ores of high grades or left as metal chlorides after removal of MgCO₃ and then supplied to refineries for metal production.

The at least one acid leacher comprises a continually stirred (or agitated) tank reactor that is rated to withstand the low pH environment. In this unlimited example, the pH to effectuate acid leaching ranges from below 0 to about 4. The systems used herein can also include a means to capture and safely release any gases, e.g., H₂S, that may be generated during acid leaching. The systems can also include means to introduce the ores to the tank reactor and withdraw any remaining solid following an acid leaching process, wherein the remaining solid can be disposed of as understood by the person skilled in the art.

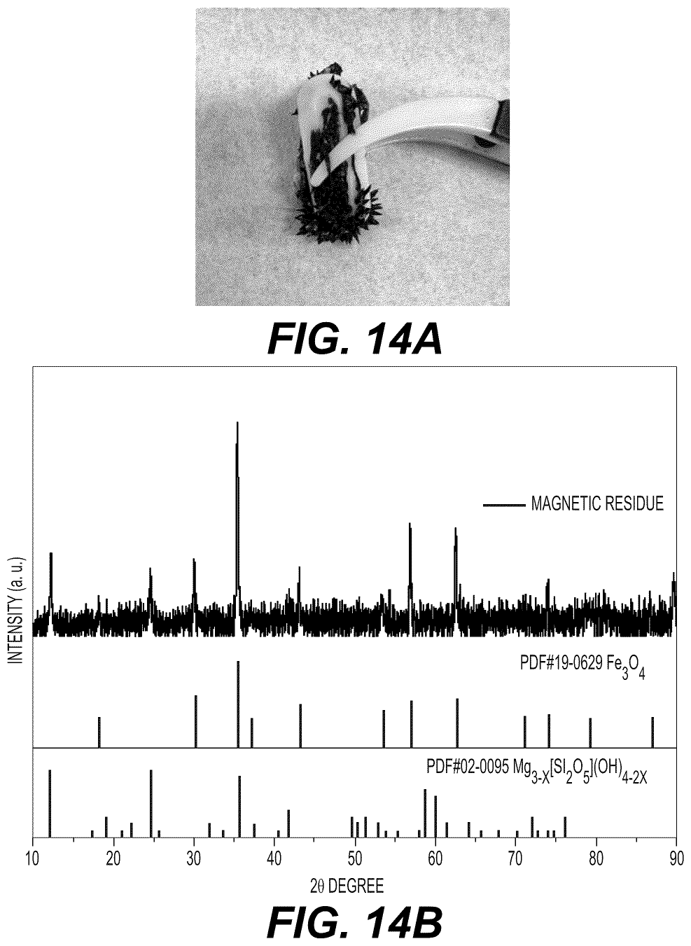

An example of serpentine ore exposed to acid leaching is shown in FIGS. 14A-14B. It can be seen that after the acid leaching, a magnetic residue can be formed (FIG. 14A). The XRD of the magnetic residue and Mg₃₋ₓ[Si₂O₅](OH)₄₋₂ₓ is shown in FIG. 14B.

A great advantage of the system and method described herein is the integrated carbon capture process. For example, the formed base solution can be used, as described in detail above, to directly capture CO₂.

2NaOH(aq)+CO₂(g)→Na₂CO₃(aq)+H₂O(I),ΔH⁰=−109.4 kJ/mol

NaOH(aq)+CO₂(g)→NaHCO₃(aq)ΔH⁰=−91.1 kJ/mol

An exemplary NaOH solution with pH=12 has a practical minimum absorption capacity of 2.08 mmol per gram of NaOH (for Na₂CO₃ formation) and a theoretical maximum capacity of 3.02 mmol per gram of NaOH (for NaHCO₃ formation), which are comparable or superior to the typical working capacity of <3 mmol/g for amine-based sorbents.

The gas source comprising CO₂ is contacted with at least a portion of the as-synthesized base in the column of the air contactor, removing some of the CO₂ from the gas source and producing a carbonate solution, which is directed to at least one metal carbonate precipitator of the system. It is understood that the metal precipitates can also comprise oxides, hydroxides, bicarbonates, carbonates, or any combination thereof. In some examples, the gas source comprising CO₂ is contacted with at least a portion of the as-synthesized base in a countercurrent manner.

In this unlimited example, acid leaching and carbon capturing generate a mixture of metal chlorides (Mn, Co, Ni, Cu, Mg, Fe, etc.)Clₓ and Na₂CO₃, respectively. To separate them, the Na₂CO₃ solution generated from the carbon capture process (e.g., pH˜12) can be used to titrate the aqueous solutions comprising solubilized target minerals comprising ions from the at least one acid leacher according to

Na₂CO₃(aq)+(Mn,Co,Ni,Cu,Mg,Fe)Clₓ(aq)→NaCl+(Mn,Co,Ni,Cu,Mg,Fe)CO₃(s)

It is noted that the different metals will precipitate at different carbonate concentrations or pH values, allowing for the separation of the target elements and the production of high-grade materials comprising the target elements that can be fed to downstream refineries. For example and without limitations, the different metal carbonates can be precipitated sequentially, e.g., Fe>Co>Cu>Mn>Mg/Ca>Ni, depending on the carbonate concentrations, Ksp values, and/or solution pH. It is understood that certain metal combinations (e.g., Co, Cu and Mn) may not be sufficiently separated from each other. While here the precipitate is described as a carbonate, it is understood that the precipitates can comprise oxides, hydroxides, bicarbonates, carbonates, or any combination thereof that are precipitated sequentially at different carbonate, bicarbonate, or hydroxide concentrations or pHs.

This will allow for the separation of targeted metals and the production of high-grade ores that can be fed to downstream refineries. The untargeted carbonates such as MgCOs and/or FeCO₃ (note that purified iron ore may also be valuable for metallurgy) can be remineralized for carbon sequestration. The overall mining process can thus become carbon negative.

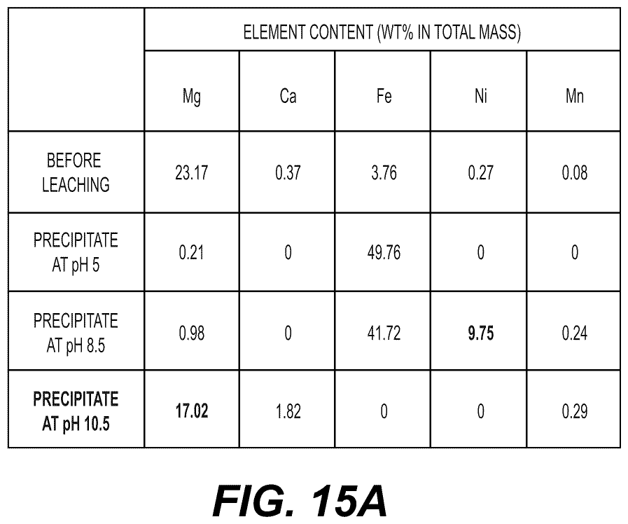

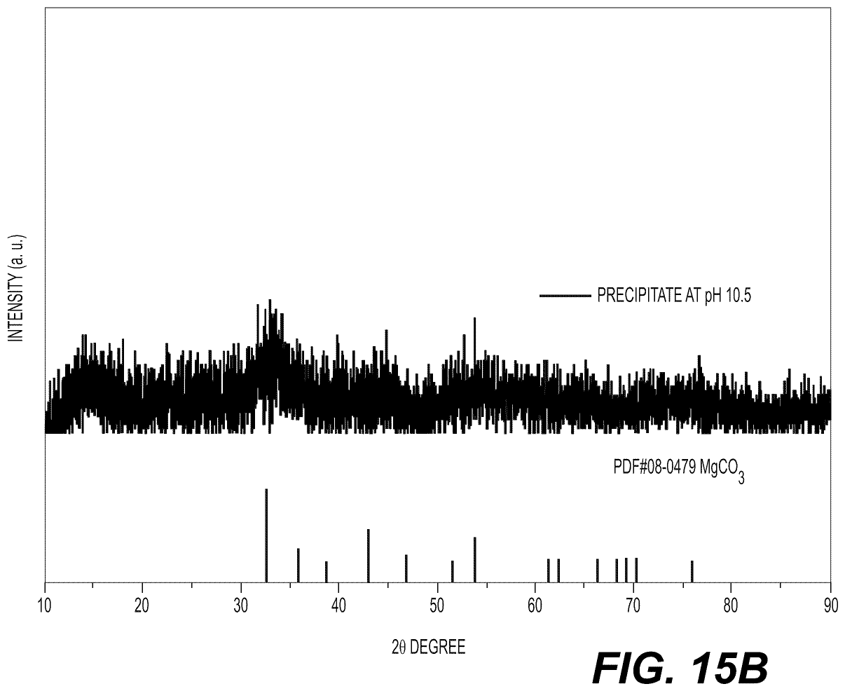

FIGS. 15A-15B show the results of the carbonation of serpentine ores with Ni enrichment and formation of MgCO₃ used for carbon sequestration.

The overall mining process can thus become carbon negative. The residual brine solution, e.g., NaCl, after the precipitation/carbonation reaction can be recycled back to the at least one electro-synthesizer to close mass balance and minimize environmental impacts.

### Example 5

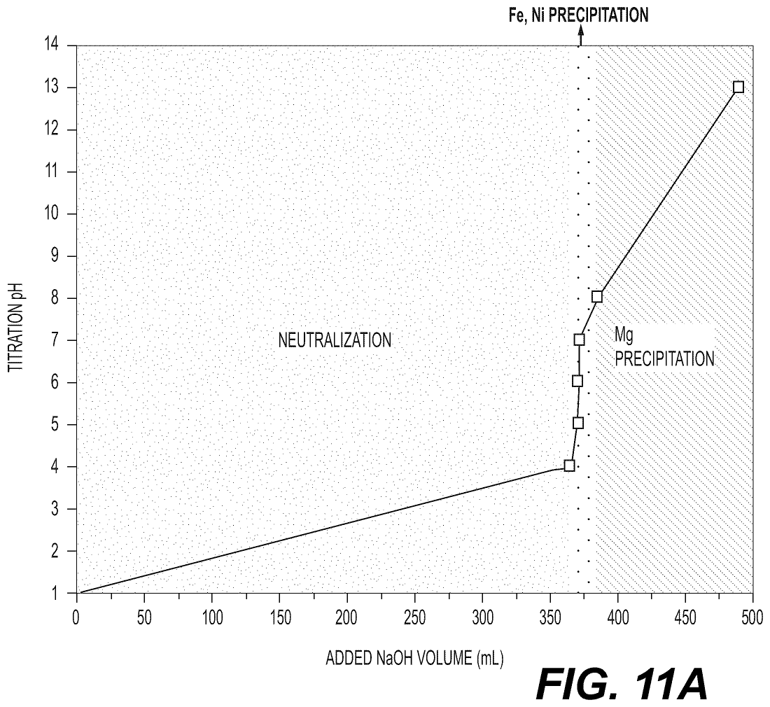

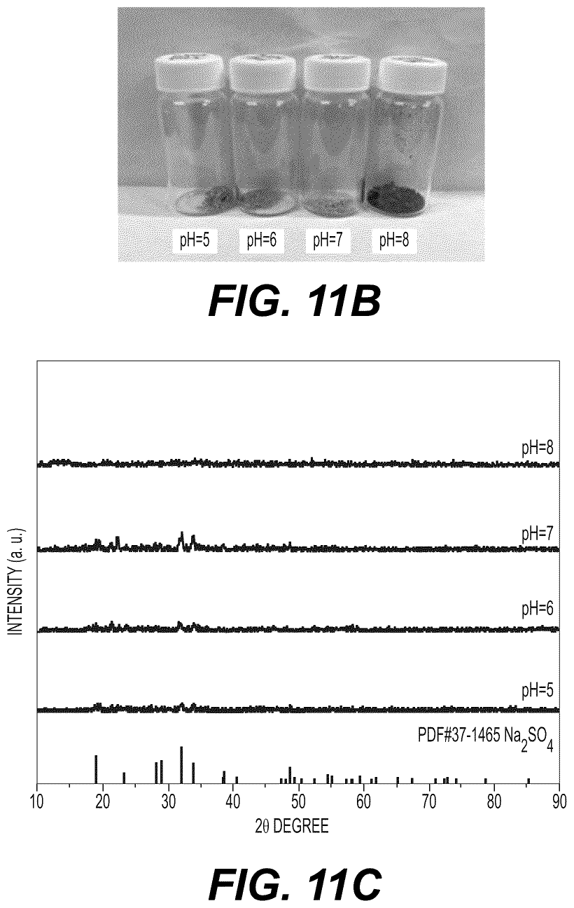

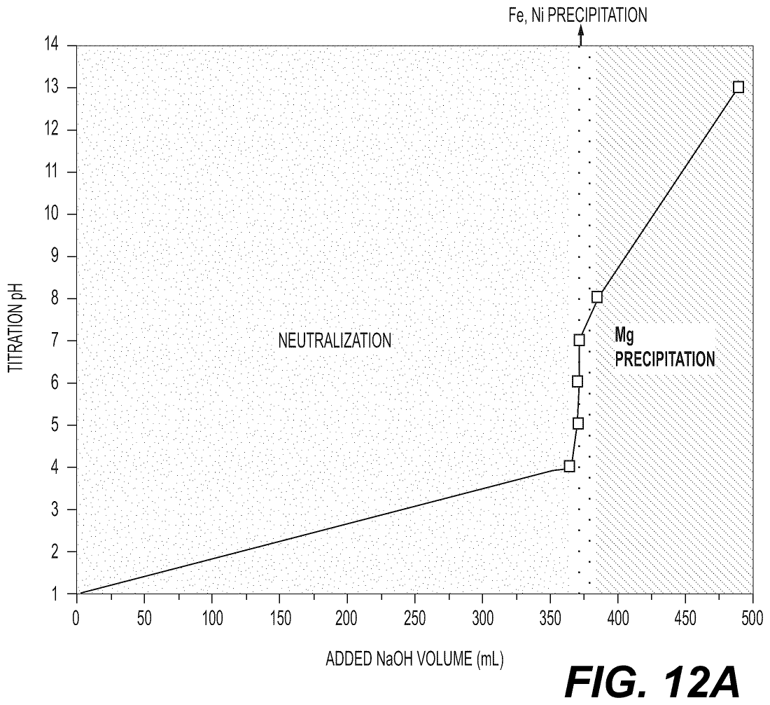

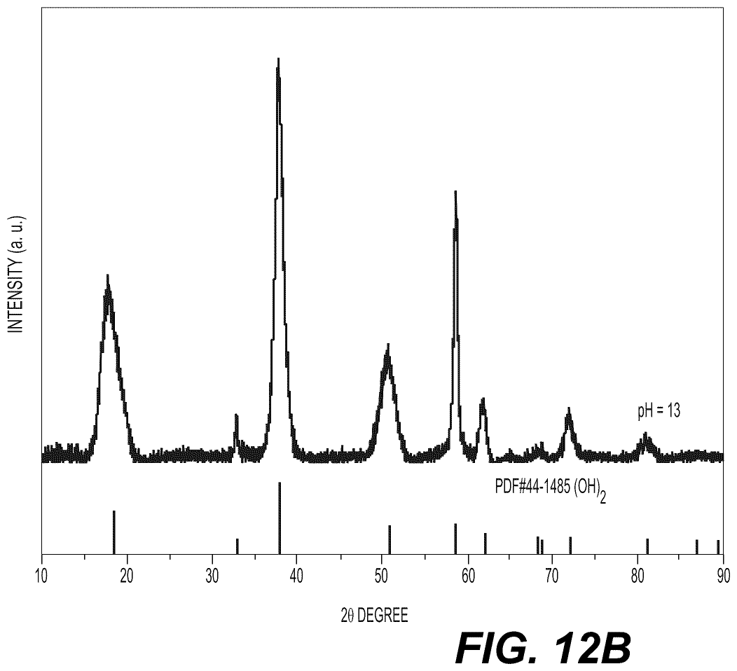

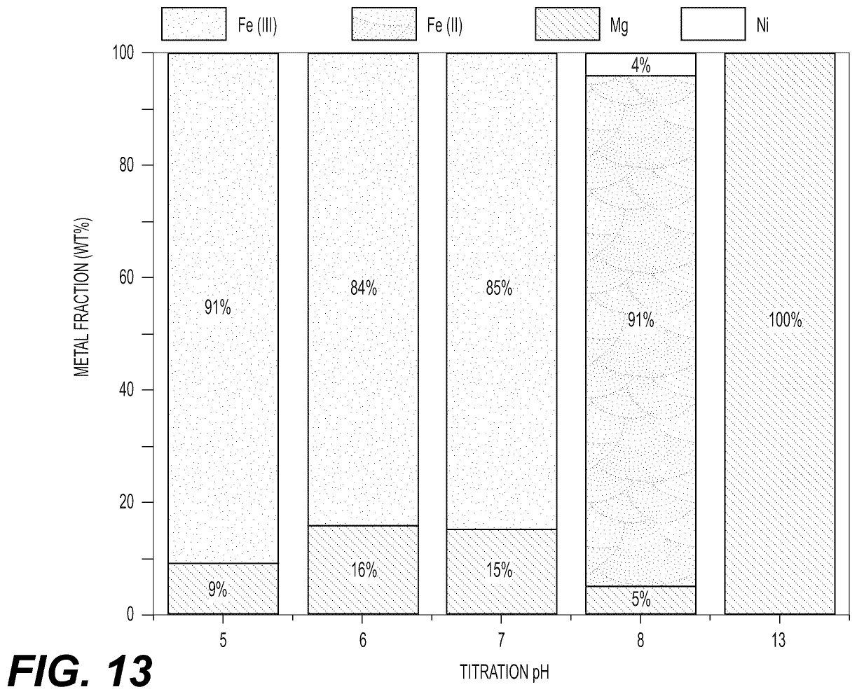

In this example, the mineral ores were titrated with base solution withdrawn from the electro-synthesizer unit using the system shown in FIG. 9. The results are shown in FIGS. 11A-11C, FIGS. 12A-12B, and FIG. 13. Various steps of the process and corresponding XRD data can be observed at different pH in FIG. 11A-12B. The percentages of the precipitated metal ions at different pHs are shown in FIG. 13. While this system is not utilizing carbon dioxide in the precipitation, it can operate in a substantially carbon-neutral mode as all chemicals are recycled within the system, and high energy savings are obtained due to the system design.

The devices, systems, and methods of the appended claims are not limited in scope by the specific devices, systems, and methods described herein, which are intended as illustrations of a few aspects of the claims. Any devices, systems, and functionally equivalent methods are intended to fall within the scope of the claims. Various modifications of the devices, systems, and methods, in addition to those shown and described herein, are intended to fall within the scope of the appended claims. Further, while only certain representative devices, systems, and method steps disclosed herein are specifically described, other combinations of the devices, systems, and method steps also are intended to fall within the scope of the appended claims, even if not specifically recited. Thus, a combination of steps, elements, components, or constituents may be explicitly mentioned herein or less; however, other combinations of steps, elements, components, and constituents are included, even though not explicitly stated.

Although several embodiments of the invention have been disclosed in the foregoing specification, it is understood by those skilled in the art that many modifications and other embodiments of the invention will come to mind to which the invention pertains, having the benefit of the teaching presented in the foregoing description and associated drawings. It is thus understood that the invention is not limited to the specific embodiments disclosed hereinabove and that many modifications and other embodiments are intended to be included within the scope of the appended claims. Moreover, although specific terms are employed herein, as well as in the claims which follow, they are used only in a generic and descriptive sense and not for the purposes of limiting the described invention or the claims which follow.

Unless defined otherwise, all technical and scientific terms used herein have the same meanings as commonly understood by one of skill in the art to which the disclosed invention belongs. Publications cited herein and the materials for which they are cited are specifically incorporated by reference.

The claims are not intended to include, and should not be interpreted to include, means-plus- or step-plus-function limitations unless such a limitation is explicitly recited in a given claim using the phrase(s) “means for” or “step for,” respectively.

In view of the described processes and compositions, hereinbelow are described certain more particularly described aspects of the inventions. These particularly recited aspects should not, however, be interpreted to have any limiting effect on any different claims containing different or more general teachings described herein or that the “particular” aspects are somehow limited in some way other than the inherent meanings of the language and formulas literally used therein.

### Exemplary Aspects

In view of the described processes and compositions, hereinbelow are described certain more particularly described aspects of the disclosures. These particularly recited aspects should not, however, be interpreted to have any limiting effect on any different claims containing different or more general teachings described herein, or that the “particular” aspects are somehow limited in some way other than the inherent meanings of the language and formulas literally used therein.

Example 1. An electro-synthesizer unit, wherein the electro-synthesizer unit is a flow unit comprising: a first compartment comprising: a first inlet configured to receive a first flow of a first electrolyte solution; a cathode; the first electrolyte solution that is in electrical and fluid communication with the cathode; wherein a pH of the first electrolyte solution is about 6≤pH≤15.5; wherein the cathode is configured to generate a hydrogen gas and a hydroxide; one or more outlets configured to remove the generated hydrogen gas and/or a base solution comprising the generated hydroxide from the first compartment; a second compartment comprising: a second inlet configured to receive a second flow of a second electrolyte solution; a third inlet configured to receive a stream comprising a hydrogen gas; an anode; and the second electrolyte solution that is in electrical and fluid communication with the anode; wherein a pH of the second electrolyte solution is about −1.5≤pH≤8; wherein the anode is configured to oxidate the hydrogen gas to generate hydrogen ions; an outlet configured to remove an acid solution comprising the generated hydrogen ions from the second compartment; and a third compartment positioned between and in fluid communication with the first compartment and the second compartment, wherein the third compartment is separated from the first compartment with one or more cation exchange membranes and is separated from the second compartment with one or more anion exchange membranes; wherein the third compartment comprises: a fourth inlet configured to receive a third flow of a third electrolyte solution; the third electrolyte solution, wherein a pH of the third electrolyte solution is about 4≤pH≤10; and an outlet configured to remove the third electrolyte from the third compartment.

Example 2. The electro-synthesizer unit of any examples herein, particularly example 1, wherein the stream comprises the hydrogen gas generated in the first compartment.

Example 3. The electro-synthesizer unit of any examples herein, particularly example 2, wherein the stream comprising the generated hydrogen gas is directly fed from the first compartment to the second compartment.

Example 4. The electro-synthesizer unit of any examples herein, particularly example 1, wherein the stream comprises a hydrogen gas supplied from an external source.

Example 5. The electro-synthesizer unit of any examples herein, particularly examples 1-4, wherein each of the first, second and third compartments are defined by two or more plates.

Example 6. The electro-synthesizer unit of any examples herein, particularly examples 1-5, wherein the second inlet of the second compartment extends into a first channel and the third inlet extends into a second channel.

Example 7. The electro-synthesizer unit of any examples herein, particularly example 6, wherein the first channel is positioned between the anion exchange membrane and a first surface of the anode.

Example 8. The electro-synthesizer unit of any examples herein, particularly example 6 or 7, wherein the second channel is positioned abut a second surface of the anode.

Example 9. The electro-synthesizer unit of any examples herein, particularly examples 1-8, wherein the electro-synthesizer unit is a recirculated-in-a-loop system.

Example 10. The electro-synthesizer unit of any examples herein, particularly examples 1-9, wherein the generated in the first compartment hydrogen gas and the base solution comprising the generated hydroxide is removed from the same outlet.

Example 11. The electro-synthesizer unit of any examples herein, particularly examples 1-10, wherein the first compartment comprises two or more outlets, wherein the generated hydrogen gas stream and the base solution comprising the generated hydroxide are removed from separate outlets.

Example 12. The electro-synthesizer unit of any examples herein, particularly examples 1-11, wherein the third compartment has a width of about 0.01 to about 500 mm.

Example 13. The electro-synthesizer unit of any examples herein, particularly examples 1-12, wherein the first compartment has a width of about 0.01 to about 500 mm.

Example 14. The electro-synthesizer unit of any examples herein, particularly examples 6-13, wherein the first channel present in the second compartment has a width of about 0.01 to about 500 mm.

Example 15. The electro-synthesizer unit of any examples herein, particularly examples 6-14, wherein the second channel present in the second compartment has a width of about 0.01 to about 500 mm.

Example 16. The electro-synthesizer unit of any examples herein, particularly examples 1-15, wherein the anode comprises a gas diffusion layer.

Example 17. The electro-synthesizer unit of any examples herein, particularly example 16, wherein the anode further comprises a hydrogen oxidation catalyst layer.

Example 18. The electro-synthesizer unit of any examples herein, particularly example 16 or 17, wherein the gas diffusion layer comprises a carbon-based gas diffusion layer, a fluorocarbon-based gas diffusion layer, a hydrophobic material comprising a plurality of pores, or any combination thereof.

Example 19. The electro-synthesizer unit of any examples herein, particularly example 18, wherein the gas diffusion layer comprises a carbon-based paper, a carbon-based textile, a modified carbon-based paper, a modified carbon-based textile, micro-porous PTFE membrane, mesoporous PTFE membrane, macro-porous PTFE membrane, or a combination thereof.

Example 20. The electro-synthesizer unit of any examples herein, particularly example 17-19, wherein the hydrogen oxidation catalyst layer comprises one of more Pt group metal (PGM) or alloys thereof-based catalysts, PGM-free catalysts, and any combination thereof.

Example 21. The electro-synthesizer unit of any examples herein, particularly example 20, wherein the hydrogen oxidation catalyst layer comprises one or more of Pt/C, Pd and its alloys, Au and its alloys, Ru and its alloys, transition metal oxides and their alloys, transition metal carbides and nitrides, metal-organic frameworks, carbon-supported metal atoms, hydrogenase, hydrogenase mimic compounds, hydrogenase, or any combinations thereof.

Example 22. The electro-synthesizer unit of any examples herein, particularly examples 1-21, wherein the cathode comprises a Pt group metal or their alloys based electrode, a Ni-and its alloys-based electrode, a NiFe-based electrode, NiTi-based electrode, steel-based electrode, transition metal sulfates-based electrode (like molybdenum sulfide, tungsten sulfide), transition metal phosphide-based electrode (like cobalt phosphide), Fe-based catalysts, carbon-based materials, or any combination thereof.

Example 23. The electro-synthesizer unit of any examples herein, particularly examples 1-22, wherein the cation and/or anion exchange membranes are polymer reinforced, wherein the polymer is inert to the first, second, and/or third electrolyte solutions.

Example 24. The electro-synthesizer unit of any examples herein, particularly example 23, wherein the cation and/or anion exchange membranes are PTFE-reinforced, PEEK reinforced, or any combination thereof.

Example 25. The electro-synthesizer unit of any examples herein, particularly examples 1-24, wherein the third electrolyte solution comprises one or more inorganic salts.

Example 26. The electro-synthesizer unit of any examples herein, particularly example 25, wherein the one or more inorganic salts comprise chlorides, sulfates, nitrates, phosphates, citrates, formates, lactates, tartrates, malates, fumarates, oxalates, succinates, gluconates, ascorbates, acetates of alkaline metals and/or alkaline-earth metals, or mixtures thereof.

Example 27. The electro-synthesizer unit of any examples herein, particularly examples 1-26, wherein the first electrolyte solution comprises a base.

Example 28. The electro-synthesizer unit of any examples herein, particularly example 27, wherein the base comprises one or more of sodium hydroxide, lithium hydroxide, potassium hydroxide, magnesium hydroxide, calcium hydroxide, ammonium hydroxide, amine-based bases, sodium acetate, or any combination thereof.

Example 29. The electro-synthesizer unit of any examples herein, particularly examples 1-28, wherein the second electrolyte solution comprises an acid.

Example 30. The electro-synthesizer unit of any examples herein, particularly example 29, wherein the acid comprises one or more of hydrochloric acid, hydrobromic acid, hydroiodic acid, sulfurous acid, sulfuric acid, nitric acid, phosphorous acid, phosphoric acid, hypochlorous acid, chlorous acid, chloric acid, perchloric acid, formic acid, acetic acid, carbonic acid, or any combination thereof.

Example 31. The electro-synthesizer unit of any examples herein, particularly examples 27-30, wherein the first electrolyte comprises one or more inorganic salts.

Example 32. The electro-synthesizer unit of any examples herein, particularly examples 29-31, wherein the second electrolyte comprises one or more inorganic salts.

Example 33. The electro-synthesizer unit of any examples herein, particularly example 31-32, wherein the one or more inorganic salt comprises chlorides, sulfates, nitrates, phosphates, citrates, formates, lactates, tartrates, malates, fumarates, oxalates, succinates, gluconates, ascorbates, acetates of alkaline metals and/or alkaline-earth metals, or mixtures thereof.

Example 34. The electro-synthesizer unit of any examples herein, particularly examples 1-33, wherein the flow of the first electrolyte, the second electrolyte, and/or the third electrolyte is the same or different.

Example 35. The electro-synthesizer unit of any examples herein, particularly example 34, wherein a flow rate is from about 1 to about 5,000,000 mL/h.

Example 36. The electro-synthesizer unit of any examples herein, particularly examples 1-35, wherein when the pH in the first compartment is about 8 to about 14.5, and wherein the pH in the second compartment is about −0.5 to about 6, the base solution removed from the one or more outlets of the first compartment and the acid solution removed from the outlet of the second compartment has a molarity of greater than 0 to less than about 3 M.

Example 37. The electro-synthesizer unit of any examples herein, particularly examples 1-36, wherein when the pH in the first compartment is about 8 to about 15.5, and wherein the pH in the second compartment is about 1 to about 6, the base solution removed from the one or more outlets of the first compartment has a molarity of greater than 0 to about 20 M.

Example 38. The electro-synthesizer unit of any examples herein, particularly examples 1-35 or 37, wherein when the pH in the first compartment is about 8 to about 15.5, and wherein the pH in the second compartment is about 1 to less than about 6, the acid solution removed from the outlet of the second compartment has a molarity of greater than 0 to about 10 M.

Example 39. A system comprising one or more of the electro-synthesizer units of any examples herein, particularly examples 1-38.

Example 40. The system of any examples herein, particularly example 39, wherein two or more electro-synthesizer units are present, and two or more electro-synthesizer units are designed to share a cathode.

Example 41. The system of any examples herein, particularly example 39 or 40, wherein three or more electro-synthesizer units are present and wherein the three or more electro-synthesizer units are configured to share the second channel of the second compartment.

Example 42. The system of any examples herein, particularly examples 39-41, wherein the system comprises from 1 to about 1000 of electro-synthesizer units.

Example 43. A method comprising: providing the electro-synthesizer unit of any examples herein, particularly examples 1-38 or the system of any examples herein, particularly examples 39-42; flowing the first electrolyte, the second electrolyte, and the third electrolyte; generating a hydrogen gas stream and a hydroxide on the cathode in the first compartment; generating hydrogen ions on the anode in the second compartment; directing a stream comprising a hydrogen gas into the second compartment; wherein the hydrogen gas present in the stream is the generated hydrogen gas and/or a hydrogen gas provided from an external source; collecting a generated base solution and a generated acid solution.

Example 44. The method of any examples herein, particularly example 43, wherein the electro-synthesizer unit operates as a recirculated-in-a-loop system.

Example 45. The method of any examples herein, particularly example 43 or 44, wherein the generated base and acid solutions have a molarity from greater than 0 to about 3 M.

Example 46. The method of any examples herein, particularly examples 43-45, wherein the generated base solution has a molarity greater than 0 to about 20 M, and the acid solution has a molarity greater than 0 to about 10 M.

Example 47. The method of any examples herein, particularly example 46, wherein at least a portion of the collected generated base and acid solution is diluted and used as the first and the second electrolyte solution, respectively.

Example 48. A system comprising: one or more flow electro-synthesizer units configured to produce an acid solution and a base solution; one or more carbon dioxide capturing apparatuses that is in fluid communication with the one or more flow electro-synthesizer units and that are configured to capture a carbon dioxide from a gas source by converting the carbon dioxide to a bicarbonate solution, carbonate solution, or a combination thereof.

Example 49. The system of any examples herein, particularly example 48, wherein the one or more flow electro-synthesizer units comprise: a first compartment comprising: a cathode; a first electrolyte solution that is in electrical and fluid communication with the cathode, wherein a pH of the first electrolyte solution is 6≤pH≤15.5; wherein the cathode is configured to generate a hydrogen gas and a base solution; a second compartment comprising: an anode; and a second electrolyte solution that is in electrical and fluid communication with the anode; wherein a pH of the second electrolyte solution is −1.5≤pH≤8; wherein the anode is configured to generate an acid solution; and a third compartment positioned between and in fluid communication with the first compartment and the second compartment and comprising: a third electrolyte solution, wherein a pH of the third electrolyte solution is 4≤pH≤10.

Example 50. The system of any examples herein, particularly example 49, wherein the first electrolyte solution comprises a base and the second electrolyte solution comprises an acid, wherein each of the electrolytes is provided at a predetermined flow rate.

Example 51. The system of any examples herein, particularly example 50, wherein the first electrolyte solution further comprises one or more inorganic salts, and/or wherein the second electrolyte further comprises one or more inorganic salts.

Example 52. The system of any examples herein, particularly examples 49-51, wherein the third electrolyte solution comprises one or more inorganic salts and is provided at a predetermined flow rate.

Example 53. The system of any examples herein, particularly examples 50-52, wherein the base comprises one or more of sodium hydroxide, lithium hydroxide, potassium hydroxide, magnesium hydroxide, calcium hydroxide, ammonium hydroxide, amine-based bases, sodium acetate, or any combination thereof.

Example 54. The system of any examples herein, particularly examples 50-53, wherein the acid comprises one or more of hydrochloric acid, hydrobromic acid, hydroiodic acid, sulfurous acid, sulfuric acid, nitric acid, phosphorous acid, phosphoric acid, hypochlorous acid, chlorous acid, chloric acid, perchloric acid, formic acid, acetic acid, carbonic acid, or any combination thereof.

Example 55. The system of any examples herein, particularly examples 51-54, wherein the one or more inorganic salts comprise chlorides, sulfates, nitrates, phosphates, citrates, formates, lactates, tartrates, malates, fumarates, oxalates, succinates, gluconates, ascorbates, acetates of alkaline metals and/or alkaline-earth metals, or mixtures thereof.

Example 56. The system of any examples herein, particularly examples 50-55, wherein the generated in the first compartment base solution is the same or different as the first electrolyte.

Example 57. The system of any examples herein, particularly examples 50-56, wherein the generated in the second compartment acid solution is the same or different as the second electrolyte.

Example 58. The system of any examples herein, particularly examples 53-57, wherein the one or more inorganic salts in the first electrolyte are the same or different as the one or more inorganic salts in the second electrolyte and/or third electrolyte.

Example 59. The system of any examples herein, particularly examples 53-58, wherein the one or more inorganic salts in the second electrolyte are the same or different as the one or more inorganic salts in the first electrolyte and/or third electrolyte.

Example 60. The system of any examples herein, particularly examples 53-59, wherein the one or more inorganic salts in the third electrolyte are the same or different as the one or more inorganic salts in the first electrolyte and/or second electrolyte.

Example 61. The system of any examples herein, particularly examples 49-60, wherein the second compartment is configured to receive a hydrogen stream to be oxidized on the anode to produce the acid solution, wherein the hydrogen stream comprises the hydrogen gas formed in the first compartment, a hydrogen provided from an external source, or a combination thereof.

Example 62. The system of any examples herein, particularly examples 49-61, wherein the third compartment is separated from the first compartment with one or more cation exchange membranes and is separated from the second compartment with one or more anion exchange membranes.

Example 63. The system of any examples herein, particularly examples 49-62, wherein at least a portion of the base solution formed in the first compartment is fed to the one or more carbon dioxide capturing apparatuses configured to capture the carbon dioxide such that the carbon dioxide is converted to the bicarbonate solution, carbonate solution, or a combination thereof by reacting the carbon dioxide from the source with the at least a portion of the base solution.

Example 64. The system of any examples herein, particularly examples 48-63, further comprising one or more neutralizers.

Example 65. The system of any examples herein, particularly example 64, wherein the one or more neutralizers are in fluid communication with the one or more carbon dioxide capturing apparatuses and one or more flow electro-synthesizer units.

Example 66. The system of any examples herein, particularly example 64 or 65, wherein the one or more neutralizers are in fluid communication with the one or more carbon dioxide capturing apparatuses and at least the second compartment of the one or more flow electro-synthesizer units.

Example 67. The system of any examples herein, particularly example 66, wherein the one or more neutralizers are in fluid communication with the third compartment of the one or more flow electro-synthesizer units.

Example 68. The system of any examples herein, particularly example 66 or 67, wherein at least a portion of the acid solution is fed into the one or more neutralizers and is reacted with the bicarbonate solution, carbonate solution, or a combination thereof to form a salt and a substantially high concentration carbon dioxide.

Example 69. The system of any examples herein, particularly example 68, wherein the substantially high concentration of carbon dioxide is collected.

Example 70. The system of any examples herein, particularly example 68 or 69, where the salt is fed into the third compartment of the one or more flow electro-synthesizer units as at least a portion of the third electrolyte.

Example 71. The system of any examples herein, particularly example 70, wherein at least a portion of the third electrolyte solution comprises the salt formed in the one or more neutralizers, and wherein the salt is the same or different from one or more inorganic salts present in the third electrolyte.

Example 72. The system of any examples herein, particularly examples 53-71, wherein the predetermined flow of the first electrolyte, the second electrolyte, and/or the third electrolyte is the same or different.

Example 73. The system of any examples herein, particularly example 72, wherein the predetermined flow rate is about 1 to about 5,000,000 mL/h.

Example 74. The system of any examples herein, particularly examples 48-73, wherein the one or more flow electro-synthesizer units operate at a voltage of about 1.0 V to about 10.0 V.

Example 75. The system of any examples herein, particularly examples 48-74, wherein the one or more flow electro-synthesizer units generate the acid solution and the base solution in a batch or in a continuous operation.

Example 76. The system of any examples herein, particularly examples 48-75, wherein the one or more flow electro-synthesizer units generate the acid solution and the base solution utilizing an energy source configured to operate continuously or in the off-peak period, wherein the energy source is a conventional power grid or a renewable energy source.

Example 77. The system of any examples herein, particularly examples 48-76, wherein one or more carbon dioxide capturing apparatuses comprise at least one air contactor.

Example 78. The system of any examples herein, particularly example 48-77, wherein the one or more carbon dioxide capturing apparatuses captures carbon dioxide such that a gas comprising less than about 200 ppm of carbon dioxide is generated.

Example 79. The system of any examples herein, particularly example 78, wherein the generated gas is substantially free of carbon dioxide.

Example 80. The system of any examples herein, particularly examples 48-79, wherein the gas source is an ambient air, industrial gas source, substantially high concentration carbon dioxide, or any combination thereof.

Example 81. The system of any examples herein, particularly example 80, wherein the gas is the ambient air.

Example 82. A method of directly capturing carbon dioxide from a gas source, wherein the method comprises: providing one or more of the systems of any one of examples 48-81, comprising one or more flow electro-synthesizer units of any one of claims 49-81, electrochemically generating a hydrogen gas and hydroxide ions on the cathode in the first compartment; flowing a stream comprising a generated hydrogen gas, a hydrogen gas provided by an external source, or a combination thereof, to the second compartment, such that electrochemically generated hydrogen ions are formed on the anode; and directing a portion of the cathode electrolyte comprising the generated hydroxide ions to one or more carbon dioxide capturing apparatuses configured to capture a carbon dioxide from a gas source by converting the carbon dioxide to a bicarbonate solution, carbonate solution, or a combination thereof.

Example 83. The method of any examples herein, particularly example 82, further comprising directing the bicarbonate solution, carbonate solution, or a combination thereof to one or more neutralizers that is in fluid communication with the one or more carbon dioxide capturing apparatuses.

Example 84. The method of e any examples herein, particularly example 83, wherein the one or more neutralizers are in fluid communication with at least the second compartment of the one or more flow electro-synthesizer units.

Example 85. The method of any examples herein, particularly example 84, wherein a portion of an acid solution comprising the generated hydrogen ions is fed into the one or more neutralizers and is reacted with the bicarbonate solution, carbonate solution, or a combination thereof, to form a salt and a substantially high concentration carbon dioxide.

Example 86. The method of any examples herein, particularly example 84, wherein a substantially high concentration of carbon dioxide is collected.

Example 87. The method of any examples herein, particularly examples 84-86, wherein the one or more neutralizers are in fluid communication with the third compartment of the one or more flow electro-synthesizer units.

Example 88. The method of any examples herein, particularly example 87, wherein the salt formed in the one or more neutralizers is fed into the third compartment of the one or more flow electro-synthesizer units as at least a portion of the third electrolyte.

Example 89. The method of any examples herein, particularly examples 82-88, wherein the one or more flow electro-synthesizer units generate the hydrogen ions in the second compartment and the hydroxide ions in the first compartment in a batch or in a continuous operation.

Example 90. The method of any examples herein, particularly examples 82-89, wherein the one or more flow electro-synthesizer units generate the hydrogen ions in the second compartment and the hydroxide ions in the first compartment utilizing an energy source configured to operate continuously or in an off-peak period, wherein the energy source is a conventional power grid or a renewable energy source.

Example 91. The method of any examples herein, particularly examples 82-90, wherein one or more carbon dioxide capturing apparatuses comprise at least one air contactor.

Example 92. The method of any examples herein, particularly example 82-91, wherein the one or more carbon dioxide capturing apparatuses captures carbon dioxide such that a gas comprising less than about 200 ppm of carbon dioxide is generated.

Example 93. The method of any examples herein, particularly example 92, wherein the generated gas is substantially free of carbon dioxide.

Example 94. The method of any examples herein, particularly examples 83-93, wherein the gas source is an ambient air, industrial gas source, or any combination thereof

Example 95. The method of any examples herein, particularly example 94, wherein the gas is the ambient air.

Example 96. The method of any examples herein, particularly examples 35-95, wherein the method is carried out at room temperature.

Example 97. The method of any examples herein, particularly examples 82-96, wherein the method exhibits coulombic efficiency of about 90% to 100%.

Example 98. A system comprising: one or more flow electro-synthesizer units configured to produce an acid solution and a base solution; one or more carbon dioxide capturing apparatuses that is in fluid communication with the one or more flow electro-synthesizer units and that are configured to capture a carbon dioxide from a gas source by converting the carbon dioxide to a bicarbonate solution, carbonate solution, or a combination thereof; one or more acid leachers that are in fluid communication with the one or more flow electro-synthesizer units and that are configured to receive a mineral ore comprising one or more metal minerals and to form one or more solubilized minerals; and one or more precipitators that are in fluid communication with the one or more acid leachers and with the one or more carbon dioxide capturing apparatuses and that is configured to precipitate at least a portion of the one or more solubilized minerals.

Example 99. The system of any examples herein, particularly example 98, wherein the one or more flow electro-synthesizer units comprise: a first compartment comprising: a cathode; a first electrolyte solution that is in electrical and fluid communication with the cathode; wherein a pH of the first electrolyte solution is 6≤pH≤15.5; wherein the cathode is configured to generate a hydrogen gas and a base solution; a second compartment comprising: an anode; and a second electrolyte solution that is in electrical and fluid communication with the anode; wherein a pH of the second electrolyte solution is −1.5≤pH≤8; wherein the anode is configured to generate an acid solution; and a third compartment positioned between and in fluid communication with the first compartment and the second compartment and comprising: a third electrolyte solution, wherein a pH of the third electrolyte solution is 4≤pH≤10.

Example 100. The system of any examples herein, particularly example 99, wherein the first electrolyte solution comprises a base and the second electrolyte solution comprises an acid, wherein each of the electrolytes is provided at a predetermined flow rate.

Example 101. The system of any examples herein, particularly example 100, wherein the first electrolyte solution further comprises one or more inorganic salts, and/or wherein the second electrolyte further comprises one or more inorganic salts.

Example 102. The system of any examples herein, particularly example 100-101, wherein the third electrolyte solution comprises one or more inorganic salts provided at a predetermined flow rate.

Example 103. The system of any examples herein, particularly example 100-102, wherein the base comprises one or more of sodium hydroxide, lithium hydroxide, potassium hydroxide, magnesium hydroxide, calcium hydroxide, ammonium hydroxide, amine-based bases, sodium acetate, or any combination thereof.

Example 104. The system of any examples herein, particularly examples 100-103, wherein the acid comprises one or more of hydrochloric acid, hydrobromic acid, hydroiodic acid, sulfurous acid, sulfuric acid, nitric acid, phosphorous acid, phosphoric acid, hypochlorous acid, chlorous acid, chloric acid, perchloric acid, formic acid, acetic acid, carbonic acid, or any combination thereof.

Example 105. The system of any examples herein, particularly examples 101-104, wherein the one or more inorganic salts comprise chlorides, sulfates, nitrates, phosphates, citrates, formates, lactates, tartrates, malates, fumarates, oxalates, succinates, gluconates, ascorbates, acetates of alkaline metals and/or alkaline-earth metals, or mixtures thereof.

Example 106. The system of any examples herein, particularly example 105, wherein the one or more inorganic salts are selected from sodium chloride, potassium chloride, lithium chloride, sodium bromide, potassium bromide, lithium bromide, sodium iodide, potassium iodide, lithium iodide, sodium sulfite, potassium sulfite, lithium sulfite, sodium sulfate, potassium sulfate, lithium sulfate, sodium nitrate, potassium nitrate, lithium nitrate, sodium nitrite, potassium nitrite, lithium nitrite, sodium phosphite, potassium phosphite, lithium phosphite sodium phosphate, potassium phosphate, lithium phosphate, sodium hypochlorite, potassium sodium chlorate, potassium chlorate, lithium chlorate, sodium perchlorate, potassium perchlorate, and lithium perchlorate, or any combination thereof.

Example 107. The system of any examples herein, particularly example 100-106, wherein the generated in the first compartment base solution is the same or different as the first electrolyte.

Example 108. The system of any examples herein, particularly example 100-107, wherein the generated in the second compartment acid solution is the same or different as the second electrolyte.

Example 109. The system of any examples herein, particularly examples 102-108, wherein the one or more inorganic salts in the first electrolyte are the same or different as the one or more inorganic salts in the second electrolyte and/or third electrolyte.

Example 110. The system of any examples herein, particularly examples 102-109, wherein the one or more inorganic salts in the second electrolyte are the same or different as the one or more inorganic salts in the first electrolyte and/or third electrolyte.

Example 111. The system of any examples herein, particularly examples 102-110, wherein the one or more inorganic salts in the third electrolyte are the same or different as the one or more inorganic salts in the first electrolyte and/or second electrolyte.

Example 112. The system of any examples herein, particularly examples 99-111, wherein the second compartment is configured to receive a hydrogen stream to be oxidized on the anode to produce the acid solution, wherein the hydrogen stream comprises the hydrogen gas formed in the first compartment, a hydrogen provided from an external source, or a combination thereof.

Example 113. The system of any examples herein, particularly examples 99-112, wherein the third compartment is separated from the first compartment with one or more cation exchange membranes and is separated from the second compartment with one or more anion exchange membranes.

Example 114. The system of any examples herein, particularly examples 102-113, wherein the predetermined flow of the first electrolyte, the second electrolyte, and/or the third electrolyte is the same or different.

Example 115. The system of any examples herein, particularly example 114, wherein the predetermined flow rate is about 1 to about 5,000,000 mL/h.

Example 116. The system of any examples herein, particularly example 99-115, wherein the one or more flow electro-synthesizer units operate at a voltage of about 1.0 V to about 10.0 V.

Example 117. The system of any examples herein, particularly example 99-116, wherein the one or more flow electro-synthesizer units generate the acid solution and the base solution in a batch or in a continuous operation.

Example 118. The system of any examples herein, particularly example 99-117, wherein the one or more flow electro-synthesizer units generate the acid solution and the base solution utilizing an energy source configured to operate continuously or in the off-peak period, wherein the energy source is a conventional power grid or a renewable energy source.

Example 119. The system of any examples herein, particularly examples 99-118, wherein at least a portion of the base solution formed in the first compartment is fed to the one or more carbon dioxide capturing apparatuses configured to capture the carbon dioxide such that the carbon dioxide is converted to the bicarbonate solution, carbonate solution, or a combination thereof by reacting the carbon dioxide from the source with the at least a portion of the base solution.

Example 120. The system of any examples herein, particularly example 100-119, wherein one or more carbon dioxide capturing apparatuses comprise at least one air contactor.

Example 121. The system of any examples herein, particularly example 98-120, wherein the one or more carbon dioxide capturing apparatuses captures carbon dioxide such that a gas comprising less than about 200 ppm of carbon dioxide is generated.

Example 122. The system of any examples herein, particularly example 121, wherein the generated gas is substantially free of carbon dioxide.

Example 123. The system of any examples herein, particularly examples 98-122, wherein the gas source is an ambient air, industrial gas source, or any combination thereof.

Example 124. The system of any examples herein, particularly example 123, wherein the gas is the ambient air.

Example 125. The system of any examples herein, particularly example 99-124, wherein at least a portion of the acid solution formed in the second compartment is fed to one or more acid leachers.

Example 126. The system of any examples herein, particularly examples 98-125, wherein at least a portion of the bicarbonate solution, carbonate solution, or a combination thereof collected from the one or more carbon dioxide capturing apparatuses and at least a portion of the one or more solubilized minerals formed in the one or more acid leachers are fed into the one or more precipitators to generate a precipitate comprising one or more mineral oxides, hydroxides, bicarbonates, carbonates, or any combination thereof.

Example 127. The system of any examples herein, particularly example 126, wherein the one or more oxides, hydroxides, bicarbonates, carbonates, or any combination thereof, comprise alkaline-earth metals, Group Ill metals, transition metals, rare-earth minerals, or any combination thereof.

Example 128. The system of any examples herein, particularly examples 126 or 127, wherein the one or more oxides, hydroxides, bicarbonates, carbonates, or any combination thereof, are separated by preferential precipitation.

Example 129. The system of any examples herein, particularly examples 126-128, wherein the one or more mineral b oxides, hydroxides, bicarbonates, carbonates, or any combination thereof, are precipitated together.

Example 130. The system of any examples herein, particularly examples 98-129, wherein the at least a portion of the precipitated minerals is collected.

Example 131. The system of any examples herein, particularly examples 98-130, wherein a portion of the at least a portion of the precipitated minerals is used for carbon dioxide sequestration.

Example 132. The system of any examples herein, particularly examples 126-132, wherein the one or more precipitators further comprise the one or more inorganic salts.

Example 133. The system of any examples herein, particularly example 133, where the one or more inorganic salts are fed to the third compartment of the one or more of flow electro-synthesizer units.

Example 134. A method comprising providing one or more of the systems of any examples herein, particularly example 98-133, comprising one or more flow electro-synthesizer units of any examples herein, particularly example 99-133; electrochemically generating a hydrogen gas and hydroxide ions on the cathode in the first compartment; flowing a stream comprising a generated hydrogen gas, a hydrogen gas provided by an external source, or a combination thereof, such that electrochemically generated hydrogen ions are formed on the anode; directing a portion of the cathode electrolyte comprising the hydroxide ions to one or more carbon dioxide capturing apparatuses configured to capture a carbon dioxide from a gas source by converting the carbon dioxide to a bicarbonate solution, carbonate solution, or a combination thereof; directing a portion of the anode electrolyte comprising hydrogen ions to one or more acid leachers, wherein the one or more acid leachers comprise a mineral ore comprising one or more metal minerals, and forming an aqueous solution comprising one or more solubilized minerals; and directing the bicarbonate solution, carbonate solution, or a combination thereof and the aqueous solution comprising one or more solubilized minerals to one or more precipitators to precipitate at least a portion of the one or more solubilized minerals.

Example 135. The method of any examples herein, particularly example 134, wherein the ores are size-reduced and have an average size of about 5 mm to about 100 μm.

Example 136. A system comprising: one or more flow electro-synthesizer units configured to produce an acid solution and a base solution; one or more acid leachers that are in fluid communication with the one or more flow electro-synthesizer and that are configured to receive a mineral ore comprising one or more metal minerals and form one or more solubilized minerals; and one or more enrichers that are in fluid communication with the one or more acid leachers and with the one or more flow electro-synthesizer units and that are configured to form an enriched mineral ore.

Example 137. The system of any examples herein, particularly example 136, wherein the one or more flow electro-synthesizer units comprise: a first compartment comprising: a cathode; a first electrolyte solution that is in electrical and fluid communication with the cathode; wherein a pH of the first electrolyte solution is 6≤pH≤15.5; wherein the cathode is configured to generate a hydrogen gas and a base solution; a second compartment comprising: an anode; and a second electrolyte solution that is in electrical and fluid communication with the anode; wherein a pH of the second electrolyte solution is −1.5≤pH≤8; wherein the anode is configured to generate an acid solution; and a third compartment positioned between and in fluid communication with the first compartment and the second compartment and comprising: a third electrolyte solution, wherein a pH of the third electrolyte solution is 4≤pH≤10.

Example 138. The system of any examples herein, particularly example 137, wherein the first electrolyte solution comprises a base and the second electrolyte solution comprises an acid wherein each electrolyte is provided at a predetermined flow rate.

Example 139. The system of any examples herein, particularly example 138, wherein the first electrolyte solution further comprises one or more inorganic salts, and/or wherein the second electrolyte further comprises one or more inorganic salts.

Example 140. The system of any examples herein, particularly examples 137-139, wherein the third electrolyte solution comprises one or more inorganic salts provided at a predetermined flow rate.

Example 141. The system of any examples herein, particularly examples 138-140, wherein the base comprises one or more of sodium hydroxide, lithium hydroxide, potassium hydroxide, magnesium hydroxide, calcium hydroxide, ammonium hydroxide, amine-based bases, sodium acetate, or any combination thereof.

Example 142. The system of any examples herein, particularly examples 138-141, wherein the acid comprises one or more of hydrochloric acid, hydrobromic acid, hydroiodic acid, sulfurous acid, sulfuric acid, nitric acid, phosphorous acid, phosphoric acid, hypochlorous acid, chlorous acid, chloric acid, perchloric acid, formic acid, acetic acid, carbonic acid, or any combination thereof.

Example 143. The system of any examples herein, particularly examples 139-142, wherein the one or more inorganic salts comprise chlorides, sulfates, nitrates, phosphates, citrates, formates, lactates, tartrates, malates, fumarates, oxalates, succinates, gluconates, ascorbates, acetates of alkaline metals and/or alkaline-earth metals, or mixtures thereof.

Example 144. The system of any examples herein, particularly example 143, wherein the one or more inorganic salts are selected from sodium chloride, potassium chloride, lithium chloride, sodium bromide, potassium bromide, lithium bromide, sodium iodide, potassium iodide, lithium iodide, sodium sulfite, potassium sulfite, lithium sulfite, sodium sulfate, potassium sulfate, lithium sulfate, sodium nitrate, potassium nitrate, lithium nitrate, sodium nitrite, potassium nitrite, lithium nitrite, sodium phosphite, potassium phosphite, lithium phosphite sodium phosphate, potassium phosphate, lithium phosphate, sodium hypochlorite, potassium sodium chlorate, potassium chlorate, lithium chlorate, sodium perchlorate, potassium perchlorate, and lithium perchlorate, or any combination thereof.

Example 145. The system of any examples herein, particularly examples 137-145, wherein the generated in the first compartment base solution is the same or different as the first electrolyte.

Example 146. The system of any examples herein, particularly examples 137-146, wherein the generated in the second compartment acid solution is the same or different as the second electrolyte.

Example 147. The system of any examples herein, particularly examples 140-146, wherein the one or more inorganic salts in the first electrolyte are the same or different as the one or more inorganic salts in the second electrolyte and/or third electrolyte.

Example 148. The system of any examples herein, particularly examples 140-147, wherein the one or more inorganic salts in the second electrolyte are the same or different as the one or more inorganic salts in the first electrolyte and/or third electrolyte.

Example 149. The system of any examples herein, particularly examples 140-148, wherein the one or more inorganic salts in the third electrolyte are the same or different as the one or more inorganic salts in the first electrolyte and/or second electrolyte.

Example 150. The system of any examples herein, particularly examples 137-149, wherein the second compartment is configured to receive a hydrogen stream to be oxidized on the anode to produce the acid solution, wherein the hydrogen stream comprises the hydrogen gas formed in the first compartment, a hydrogen provided from an external source, or a combination thereof.

Example 151. The system of any examples herein, particularly examples 137-150, wherein the third compartment is separated from the first compartment with one or more cation exchange membranes and is separated from the second compartment with one or more anion exchange membranes.

Example 152. The system of any examples herein, particularly examples 140-151, wherein the predetermined flow of the first electrolyte, the second electrolyte, and/or the third electrolyte is the same or different.

Example 153. The system of any examples herein, particularly example 152, wherein the predetermined flow rate is about 1 to about 5,000,000 mL/h.

Example 154. The system of any examples herein, particularly examples 136-153, wherein the one or more flow electro-synthesizer units operate at a voltage of about 1.0 V to about 10.0 V.

Example 155. The system of any examples herein, particularly examples 136-154, wherein the one or more flow electro-synthesizer units generate the acid solution and the base solution in a batch or in a continuous operation.

Example 156. The system of any examples herein, particularly examples 136-155, wherein the one or more flow electro-synthesizer units generate the acid solution and the base solution utilizing an energy source configured to operate continuously or in the off-peak period, wherein the energy source is a conventional power grid or a renewable energy source.

Example 157. The system of any examples herein, particularly examples 137-156, wherein at least a portion of the acid solution formed in the second compartment is fed to one or more acid leachers.

Example 158. The system of any examples herein, particularly examples 137-157, wherein at least a portion of the base solution formed in the first compartment is fed to the one or more enrichers.

Example 159. The system of any examples herein, particularly examples 138-158, wherein at least a portion of the one or more solubilized minerals from the one or more acid leachers is fed into the one or more enrichers.

Example 160. The system of any examples herein, particularly examples 136-159, wherein the mineral ore and the enriched mineral ore comprise alkaline-earth metals, Group III metals, transition metals, rare-earth minerals, or any combination thereof.

Example 161. The system of any examples herein, particularly examples 136-160, wherein at least a portion of the enriched mineral ore is collected.

Example 162. A method comprising providing one or more of the systems of any examples herein, particularly example 136-162, comprising one or more flow electro-synthesizer units of any examples herein, particularly example 137-161, electrochemically generating a hydrogen gas and hydroxide ions on the cathode in the first compartment; flowing a stream comprising a generated hydrogen gas, a hydrogen gas provided by an external source, or a combination thereof, such that electrochemically generated hydrogen ions are formed on the anode; directing a portion of the anode electrolyte comprising hydrogen ions to one or more acid leachers, wherein the one or more acid leachers comprise a mineral ore comprising one or more metal minerals, and forming an aqueous solution comprising one or more solubilized minerals; and directing a portion of the cathode electrolyte comprising the hydroxide ions to the one or more enrichers, directing a portion of the aqueous solution comprising one or more solubilized minerals to the one or more enrichers forming an enriched mineral ore in the one or more enrichers.

Example 162. The method of any examples herein, particularly example 161, wherein the ores are size-reduced and have an average size of about 5 mm to about 100 μm.

### REFERENCES

1. W. Tong, et al. Electrolysis of low-grade and saline surface water. Nature Energy, 5 (5), 367-377, 2020.
2. H.-W. Lin, et al. Direct anodic hydrochloric acid and cathodic caustic production during water electrolysis. Sci. Rep. 6, 20494 (2016).
3. A. Kumar, et al. Direct electrosynthesis of sodium hydroxide and hydrochloric acid from brine streams. Nature Catalysis, 2 (2), 106-113, 2019.
4. M. Reig, et al. Integration of monopolar and bipolar electrodialysis for valorization of seawater reverse osmosis desalination brines: production of strong acid and base. Desalination 398, 87-97 (2016)
5. Faverjon, F., Durand, G., & Rakib, M. (2006). Regeneration of hydrochloric acid and sodium hydroxide from purified sodium chloride by membrane electrolysis using a hydrogen diffusion anode-membrane assembly. Journal of Membrane Science, 284 (1-2), 323-330.
6. J. Van Herk, H. S. Pietersen, R. D. Schuiling, Neutralization of industrial waste acids with olivine—The dissolution of forsteritic olivine at 40-70° C., Chem. Geology, 1989, 76 (3-4), 341-352, DOI: 10.1016/0009-2541 (89) 90102-2.
7. Direct Air Capture of CO₂ with Chemicals, A Technology Assessment for the APS Panel on Public Affairs, Jun. 1, 2011, https://www.aps.org/policy/reports/assessments/upload/dac2011.pdf.
8. F. Wang, D. Dreisinger, M. Jarvis, T. Hitchins, L. Trytten, CO₂ mineralization and concurrent utilization for nickel conversion from nickel silicates to nickel sulfides, 2021, Chem. Eng. J., 406, 126761, DOI: 10.1016/j.cej.2020.126761.
9. K. C. Sole, J. Parker, P. M. Cole, M. B. Mooiman, Flowsheet Options for Cobalt Recovery in African Copper-cobalt Hydrometallurgy Circuits, Mineral Processing and Extractive Metallurgy Rev., 2019, 40 (3), 194-206, DOI: 10.1080/08827508.2018.1514301

1.-50. (canceled)

51. A system comprising:
one or more flow electro-synthesizer units configured to produce an acid solution and a base solution;
one or more carbon dioxide capturing apparatuses that is in fluid communication with the one or more flow electro-synthesizer units and that are configured to capture a carbon dioxide from a gas source by converting the carbon dioxide to a bicarbonate solution, carbonate solution, or a combination thereof;
one or more acid leachers that are in fluid communication with the one or more flow electro-synthesizer units and that are configured to receive a mineral ore comprising one or more metal minerals and to form one or more solubilized minerals; and
one or more precipitators that are in fluid communication with the one or more acid leachers and with the one or more carbon dioxide capturing apparatuses and that are configured to precipitate at least a portion of the one or more solubilized minerals.

52. The system of claim 51, wherein the one or more flow electro-synthesizer units comprise:
a first compartment comprising:
a cathode;
a first electrolyte solution that is in electrical and fluid communication with the cathode; wherein a pH of the first electrolyte solution is 6≤pH≤15.5;
wherein the cathode is configured to generate a hydrogen gas and a base solution;
a second compartment comprising:
an anode; and
a second electrolyte solution that is in electrical and fluid communication with the anode; wherein a pH of the second electrolyte solution is −1.5≤pH≤8;
wherein the anode is configured to generate an acid solution; and
a third compartment positioned between and in fluid communication with the first compartment and the second compartment and comprising:
a third electrolyte solution, wherein a pH of the third electrolyte solution is 4≤pH≤10.

53. The system of claim 52, wherein the first electrolyte solution comprises a base and optionally one or more inorganic salts, and the second electrolyte solution comprises an acid and optionally one or more inorganic salts, and the third electrolyte solution comprises one or more inorganic salts, wherein each of the electrolyte solutions are independently provided at a predetermined flow rate.

54.-55. (canceled)

56. The system of claim 53, wherein the base comprises one or more of sodium hydroxide, lithium hydroxide, potassium hydroxide, magnesium hydroxide, calcium hydroxide, ammonium hydroxide, amine-based bases, sodium acetate, or any combination thereof.

57. The system of claim 53, wherein the acid comprises one or more of hydrochloric acid, hydrobromic acid, hydroiodic acid, sulfurous acid, sulfuric acid, nitric acid, phosphorous acid, phosphoric acid, hypochlorous acid, chlorous acid, chloric acid, perchloric acid, formic acid, acetic acid, carbonic acid, or any combination thereof.

58.-59. (canceled)

60. The system of claim 53, wherein the generated in the first compartment base solution is the same or different as the first electrolyte solution, and/or the generated in the second compartment acid solution is the same or different as the second electrolyte solution.

61. (canceled)

62. The system of claim 53, wherein the one or more inorganic salts in the first electrolyte solution are the same or different as the one or more inorganic salts in the second electrolyte solution and are the same or different as one or more inorganic salts in the third electrolyte solution.

63.-64. (canceled)

65. The system of claim 52, wherein the second compartment is configured to receive a hydrogen stream to be oxidized on the anode to produce the acid solution, wherein the hydrogen stream comprises the hydrogen gas formed in the first compartment, a hydrogen provided from an external source, or a combination thereof.

66. The system of claim 52, wherein the third compartment is separated from the first compartment with one or more cation exchange membranes and is separated from the second compartment with one or more anion exchange membranes.

67. The system of claim 55, wherein the predetermined flow of the first electrolyte solution, the second electrolyte solution, and/or the third electrolyte solution is the same as or different from one another.

68. (canceled)

69. The system of claim 52, wherein the one or more flow electro-synthesizer units operate at a voltage of about 1.0 V to about 10.0 V.

70.-71. (canceled)

72. The system of claim 52, wherein at least a portion of the base solution formed in the first compartment is fed to the one or more carbon dioxide capturing apparatuses configured to capture the carbon dioxide such that the carbon dioxide is converted to the bicarbonate solution, carbonate solution, or a combination thereof by reacting the carbon dioxide from the source with the at least a portion of the base solution.

73. The system of claim 51, wherein one or more carbon dioxide capturing apparatuses comprise at least one air contactor.

74.-75. (canceled)

76. The system of claim 51, wherein the gas source is an ambient air, industrial gas source, or any combination thereof.

77. (canceled)

78. The system of claim 52, wherein at least a portion of the acid solution formed in the second compartment is fed to one or more acid leachers.

79. The system of claim 51, wherein at least a portion of the bicarbonate solution, carbonate solution, or a combination thereof collected from the one or more carbon dioxide capturing apparatuses and at least a portion of the one or more solubilized minerals formed in the one or more acid leachers are fed into the one or more precipitators to generate a precipitate comprising one or more mineral oxides, hydroxides, bicarbonates, carbonates, or any combination thereof.

80. The system of claim 79, wherein the one or more mineral oxides, hydroxides, bicarbonates, carbonates, or any combination thereof, comprise alkaline-earth metals, Group III metals, transition metals, rare-earth minerals, or any combination thereof.

81. (canceled)

82. The system of claim 79, wherein the one or more mineral oxides, hydroxides, bicarbonates, carbonates, or any combination thereof, are precipitated together or separately.

83.-84. (canceled)

85. The system of claim 79, wherein the one or more precipitators further comprise one or more inorganic salts, where the one or more inorganic salts are fed to the third compartment of the one or more of flow electro-synthesizer units.

86. (canceled)

87. A method comprising
providing one or more of the systems of claim 51;
electrochemically generating a hydrogen gas and hydroxide ions on the cathode in the first compartment; and
flowing a stream comprising a generated hydrogen gas, a hydrogen gas provided by an external source, or a combination thereof, such that electrochemically generated hydrogen ions are formed on the anode;
directing a portion of the cathode electrolyte solution comprising the hydroxide ions to one or more carbon dioxide capturing apparatuses configured to capture a carbon dioxide from a gas source by converting the carbon dioxide to a bicarbonate solution, carbonate solution, or a combination thereof;
directing a portion of the anode electrolyte solution comprising hydrogen ions to one or more acid leachers, wherein the one or more acid leachers comprise a mineral ore comprising one or more metal minerals, and forming an aqueous solution comprising one or more solubilized minerals; and
directing the bicarbonate solution, carbonate solution, or a combination thereof and the aqueous solution comprising one or more solubilized minerals to one or more precipitators to precipitate at least a portion of the one or more solubilized minerals.

88.-116. (canceled)
